(19) United States
(12) Patent Application Publication
(10) Pub. No.: US 2006/0050062 A1
(43) Pub. Date: Mar. 9, 2006

(54) Input device

(76) Inventors: Masanori Ozawa, Kawasaki-shi (JP); Katsumi Hisano, Matsudo-shi (JP); Ryo Furukawa, Kawasaki-shi (JP); Minoru Mukai, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/205,981

(22) Filed: Aug. 18, 2005

(30) Foreign Application Priority Data
Aug. 19, 2004 (JP) P2004-239872

(51) Int. Cl. G09G 5/00

(52) U.S. Cl. 345/173

(57) ABSTRACT

An input device includes: a display unit indicating an image of an input position; a contact position detecting unit detecting a position of an object brought into contact with a contact detecting layer provided on a display layer of the display unit; a contact strength detecting unit detecting contact strength of the object brought into contact with the contact detecting layer; and a contact state determining unit which extracts a feature quantity of the detected contact strength, compares the extracted feature quantity with a predetermined threshold, and determines a contact state of the object.

### CROSS REFERENCE TO RELATED APPLICATIONS

This application is based upon and claims the benefit of priority from prior Japanese Patent Application 2004-239872 filed on Aug. 19, 2004; the entire contents of which are incorporated by reference herein.

### BACKGROUND OF THE INVENTION

1. Field of the Invention

The present invention relates to an input device which feeds information into a computer or the like, a computer provided with the input device, and information processing method and program.

2. Description of the Related Art

Usually, an interface for a computer terminal includes a keyboard and a mouse as an input device, and a cathode ray tube (CRT) or a liquid crystal display (LCD) as a display unit.

Further, so-called touch panels in which a display unit and an input device are laminated one over another are in wide use as interfaces for computer terminals, small portable tablet type calculators, and so on.

Japanese Patent Laid-Open Publication No. 2003-196,007 (called the “Reference”) discloses a touch panel used to enter characters into a portable phone or a personal digital assistant (PDA) which has a small front surface. (Refer to column 0037 and FIG. 2 of the Reference.)

Up to now, it is however very difficult to know whether an object such as a user's finger or an input pen is simply placed on a touch panel or whether the touch panel is depressed by such an object. This tends to lead to input errors.

The present invention is aimed at overcoming the foregoing problem of the related art, and provides an input device which can appropriately detect a contact state of an input device, a computer including such an input device, and information processing method and program.

### BRIEF SUMMARY OF THE INVENTION

According to a first aspect of the embodiment of the invention, there is provided an input device including: a display unit indicating an image of an input unit; a contact position detecting unit detecting a position of an object brought into contact with a contact detecting layer provided on a display layer of the display unit; a contact strength detecting unit detecting contact strength of the object brought into contact with the contact detecting layer; and a contact state determining unit which extracts a feature quantity of the detected contact strength, compares the extracted feature quantity with a predetermined threshold, and determines a contact state of the object.

In accordance with a second aspect, there is provided an input device including: a display unit indicating an image of an input unit; a contact position detecting unit detecting a position of an object traversing a contact position detecting layer provided on a display layer of the display unit; a contact strength detecting unit detecting contact strength of the object brought into contact with the contact detecting layer; and a contact state determining unit which extracts a feature quantity of the detected contact strength, compares the extracted feature quantity with a predetermined threshold, and determines a contact state of the object.

According to a third aspect, there is provided a microcomputer including: a display unit indicating an image of an input unit; a contact position detecting unit detecting a position of an object brought into contact with a contact detecting layer provided on a display layer of the display unit; a contact strength detecting unit detecting contact strength of the object brought into contact with the contact detecting layer; a contact state determining unit which extracts a feature quantity of the detected contact strength, compares the extracted feature quantity with a predetermined threshold, and determines a contact state of the object; and a processing unit which performs processing in accordance with the detected contact state of the object and information entered through the contact detecting layer.

With a fourth aspect, there is provided an information processing method including: indicating an image of an input device on a display unit; detecting a contact position of an object in contact with a contact detecting layer of the display unit; detecting contact strength of the object; extracting a feature quantity related to the detected contact strength; and comparing the extracted feature quantity with a predetermined threshold and determining a contact state of the object on the contact detecting layer.

In accordance with a final aspect, there is provided an information processing program enabling an input device to: indicate an image of an input device on a display unit; detect a contact position of an object brought into contact on a contact detecting layer of display unit; detect contact strength of the object brought into contact with the contact detecting layer;
extract a feature quantity related to the detected contact strength; and compare the extracted feature quantity with a predetermined threshold, and determine a contact state of the object on the contact detecting layer.

### BRIEF DESCRIPTION OF THE SEVERAL THE DRAWINGS

FIG. 1 is a perspective view of a portable microcomputer according to a first embodiment of the invention;

FIG. 2 is a perspective view of an input section of the portable microcomputer;

FIG. 3A is a perspective view of a touch panel of the portable microcomputer;

FIG. 3B is a top plan view of the touch panel of FIG. 3A;

FIG. 3C is a cross section of the touch panel of FIG. 3A;

FIG. 4 is a block diagram showing a configuration of an input device of the portable microcomputer;

FIG. 5 is a block diagram of the portable microcomputer;

FIG. 6 is a graph showing variations of a size of a contact area of an object brought into contact with the touch panel;

FIG. 7 is a graph showing variation of a size of a contact area of an object brought into contact with the touch panel in order to enter information;

FIG. 8A is a perspective view of a touch panel converting pressure into an electric signal;

FIG. 8B is a top plan view of the touch panel shown in FIG. 8A;

FIG. 8C is a cross section of the touch panel;

FIG. 9 is a schematic diagram showing the arrangement of contact detectors of the touch panel;

FIG. 10 is a schematic diagram showing contact detectors detected when they are pushed by a mild pressure;

FIG. 11 is a schematic diagram showing contact detectors detected when they are pushed by an intermediate pressure;

FIG. 12 is a schematic diagram showing contact detectors detected when they are pushed by an intermediate pressure;

FIG. 13 is a schematic diagram showing contact detectors detected when they are pushed by a large pressure;

FIG. 14 is a schematic diagram showing contact detectors detected when they are pushed by a largest pressure;

FIG. 15 is a perspective view of a lower housing of the portable microcomputer;

FIG. 16 is a top plan view of an input device of the portable microcomputer;

FIG. 17 is a top plan view of the input device;

FIG. 18 is a flowchart of information processing steps conducted by the input device;

FIG. 19 is a flowchart showing details of step S106 shown in FIG. 18;

FIG. 20 is a flowchart of further information processing steps conducted by the input device;

FIG. 21 is a flowchart showing details of step S210 shown in FIG. 20;

FIG. 22 shows hit section of a key top of the input device;

FIG. 23 shows a further example of hit section of the key top of the input device;

FIG. 24 is an exploded perspective view of display layers of an input device of a second embodiment;

FIG. 25 is a top plan view showing details of a resistance detecting layer of the input device of the second embodiment;

FIG. 26 a top plan view showing details of resistance detecting elements of the resistance detecting layer;

FIG. 27 is a schematic view of the resistance detecting layer;

FIG. 28 is a block diagram of the input device;

FIG. 29 is a flowchart of information processing steps conducted by the input device;

FIG. 30 is a perspective view of an input device of a further embodiment;

FIG. 31 is a block diagram of an input device in a still further embodiment;

FIG. 32 is a block diagram of an input device in a still further embodiment;

FIG. 33 is a block diagram of a still further embodiment; and

FIG. 34 is a perspective view of a touch panel of a further embodiment.

### DETAILED DESCRIPTION OF THE INVENTION

Various embodiments of the present invention will be described with reference to the drawings. It is to be noted that the same or similar reference numerals are applied to the same or similar parts and elements throughout the drawings, and the description of the same or similar parts and element will be omitted or simplified.

### First Embodiment

In this embodiment, the invention relates to an input device, which is a kind of an input-output device of a terminal unit for a computer.

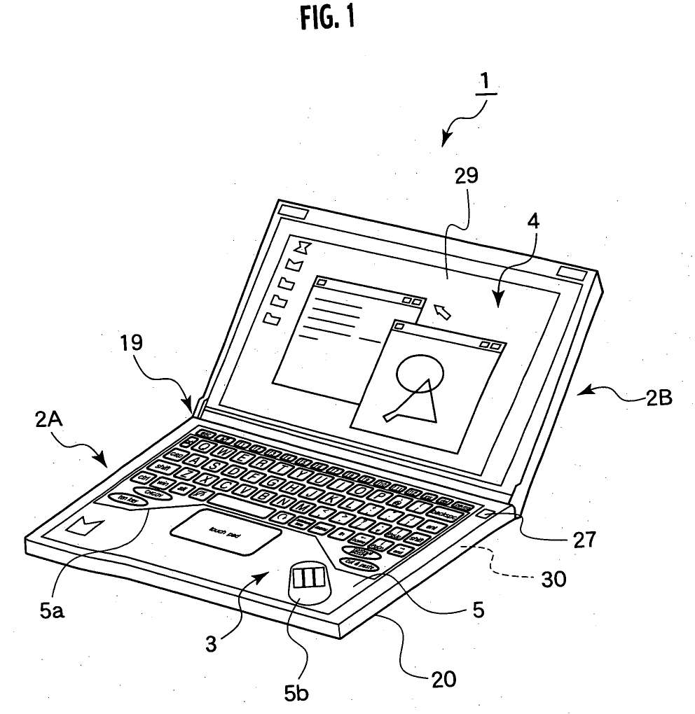

Referring to FIG. 1, a portable microcomputer 1 (called the “microcomputer 1”) includes a computer main unit 30, a lower housing 2A and an upper housing 2B. The computer main unit 30 includes an arithmetic and logic unit such as a central processing unit. The lower housing 2A houses an input unit 3 as a user interface for the computer main unit 30. The upper housing 2B houses a display unit 4 with a liquid crystal display panel 29 (called the “display panel 29”).

The computer main unit 30 uses the central processing unit in order to process information received via the input unit 3. The processed information is indicated on the display unit 4 in the upper housing 2B.

The input unit 3 in the lower housing 2A includes a display unit 5, and a detecting unit which detects a contact state of an object (such as a user's finger or an input pen) onto a display panel of the display unit 5. The display unit 5 indicates images informing a user of an input position, e.g., keys on a virtual keyboard 5a, a virtual mouse 5b, various input keys, left and right buttons, scroll wheels, and so on which are used for the user to input information.

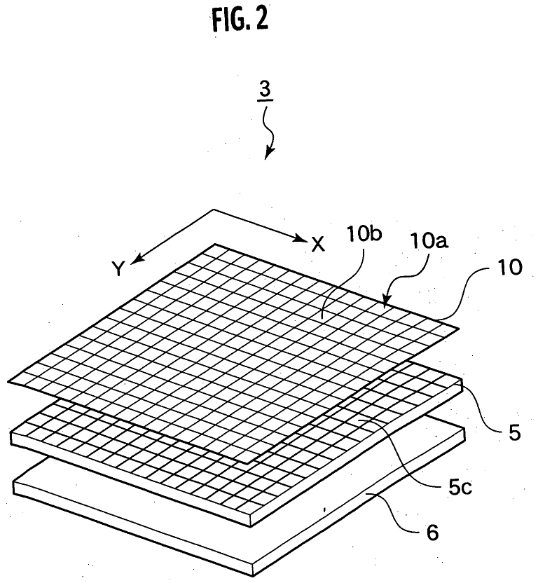

The input unit 3 further includes a backlight 6 having a light emitting area, and a touch panel 10 laminated on the display unit 5, as shown in FIG. 2. Specifically, the display unit 5 is laminated on the light emitting area of the backlight 6

The backlight 6 may be constituted by a combination of a fluorescent tube and an optical waveguide which is widely used for displays of microcomputers, or may be realized by a plurality of white light emitting diodes (LED) arranged on the flat. Such LEDs have been recently put to practical use.

Both the backlight 6 and the display unit 5 may be structured similarly to those used for display units of conventional microcomputers or those of external LCD displays for desktop computers. If the display unit 5 is light emitting type, the backlight 6 may be omitted.

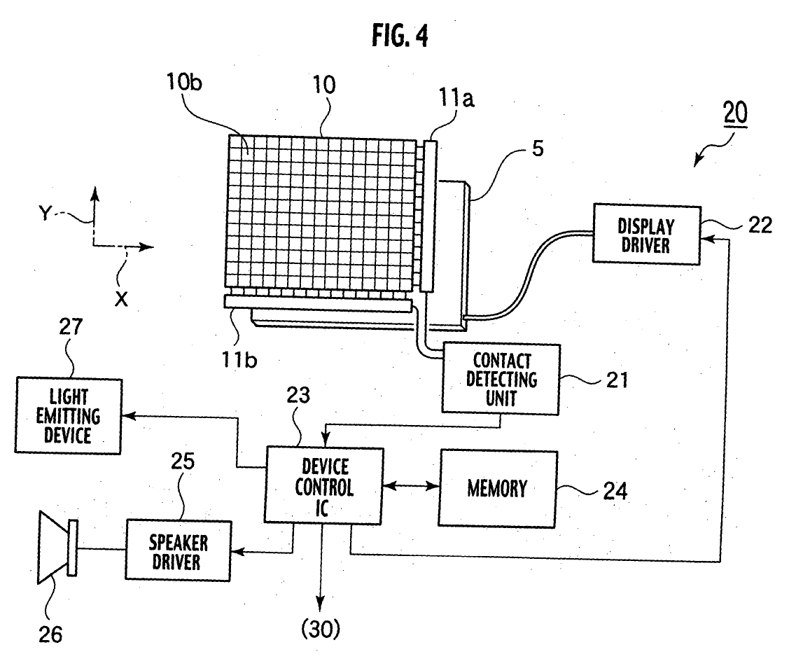

The display unit 5 includes a plurality of pixels 5c arranged in x and y directions and in the shape of a matrix, is actuated by a display driver 22 (shown in FIG. 4), and indicates an image of the input position such as the keyboard or the like.

The touch panel 10 is at the top layer of the input unit 3, is exposed on the lower housing 2A, and is actuated in order to receive information. The touch panel 10 detects an object (the user's finger or input pen) which is brought into contact with a detecting layer 10a.

In the first embodiment, the touch panel 10 is of a resistance film type. Analog and digital resistance film type touch panels are available at present. Four- to eight-wire type analog touch panels are in use. Basically, parallel electrodes are utilized, a potential of a point where the object comes into contact with an electrode is detected, and coordinates of the contact point are derived on the basis of the detected potential. The parallel electrodes are independently stacked in X and Y directions, which enables X and Y coordinates of the contact point to be detected. However, with the analog type, it is very difficult to simultaneously detect a number of contact points. Further, the analog touch panel is inappropriate for detecting dimensions of contact areas. Therefore, the digital touch panel is utilized in the first embodiment in order to detect both the contact points and dimensions of the contact areas. In any case, the contact detecting layer 10a is permeable, so that the display unit 5 is visible from the front side.

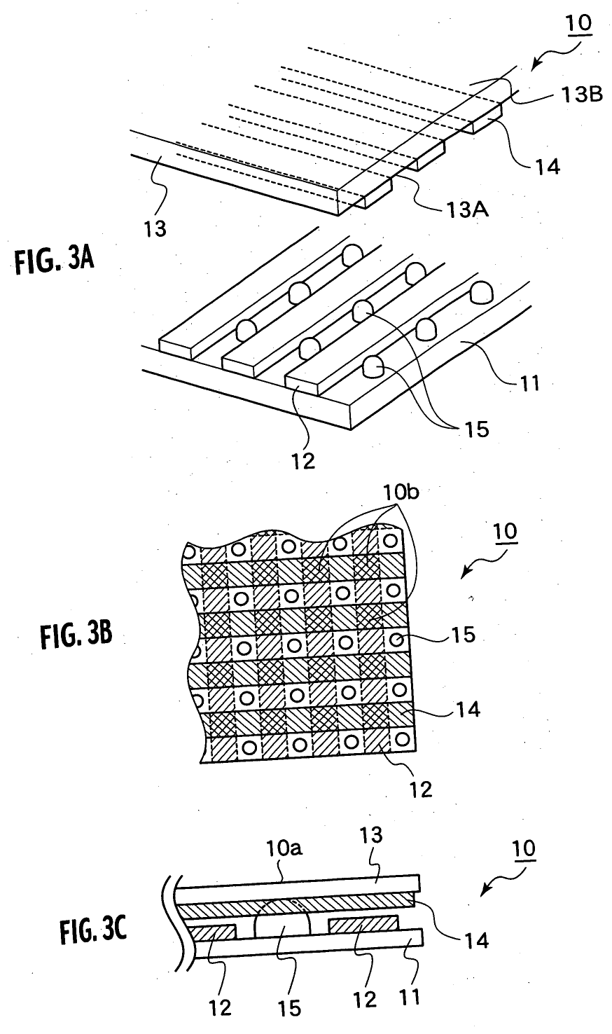

Referring to FIGS. 3A and 3B, the touch panel 10 includes a base 11 and a base 13. The base 11 includes a plurality (n) of strip-shaped X electrodes 12 which are arranged at regular intervals in the X direction. On the other hand, the base 13 includes a plurality (m) of strip-shaped Y electrodes 14 which are arranged at regular intervals in the Y direction. The bases 11 and 13 are stacked with their electrodes facing with one another. In short, the X electrodes 12 and Y electrodes 14 are orthogonal to one another. Therefore, (n×m) contact detectors 10b are arranged in the shape of a matrix at the intersections of the X electrodes 12 and Y electrodes 14.

A number of convex-curved dot spacers 15 are provided between the X electrodes on the base 11. The dot spacers 15 are made of an insulating material, and are arranged at regular intervals. The dot spacers 15 have a height which is larger than a total of thickness of the X and Y electrodes 12 and 14. The dot spacers 15 have their tops brought into contact with exposed areas 13a of the base 13 between the Y electrodes 14. As shown in FIG. 3C, the dot spacers 15 are sandwiched by the bases 11 and 13, and are not in contact with the X and Y electrodes 12 and 14. In short, the X and Y electrodes 12 and 14 are out of contact with one another by the dot spacers 15. When the base 13 is pushed in the foregoing state, the X and Y electrodes 12 and 14 are brought into contact with one another.

A surface 13B of the base 13, opposite to the surface where the Y electrodes are mounted, is exposed on the lower housing 2A, and is used to enter information. In other words, when the surface 13B is pressed by the user's finger or the input pen, the Y electrode 14 is brought into contact with the X electrode 12.

If a pressure applied by the user's finger or input pen is equal to or less than a predetermined pressure, the base 13 is not sufficiently flexed, which prevents the Y electrode 14 and the X electrode 12 from being brought into contact with each other. Only when the applied pressure is above the predetermined value, the base 13 is fully flexed, so that the Y electrode 14 and the X electrode 12 are in contact with each other and become conductive.

The contact points of the Y and X electrodes 14 and 12 are detected by the contact detecting unit 21 of the input unit 3.

With the microcomputer 1, the lower housing 2A houses not only the input unit 3 but also the input device 20 which includes contact detecting unit 21 detecting contact points of the X and Y electrodes 12 and 14 of the touch panel 10.

Referring to FIG. 2 and FIG. 4, the input device 20 includes the input unit 3, the contact detecting unit 21, a device control IC 23, a memory 24, a speaker driver 25, and a speaker 26. The device control IC 23 converts the detected contact position data into digital signals and performs I/O control related to various kinds of processing (to be described later), and communications to and from the computer main unit 30. The speaker driver 25 and speaker 26 are used to issue various verbal notices or a beep sound for notice.

The contact detecting unit 21 applies a voltage to the X electrodes 12 one after another, measures voltages at the Y electrodes 14, and detects a particular Y electrode 14 which produces a voltage equal to the voltage applied to the X electrodes.

The touch panel 10 includes a voltage applying unit 11a, which is constituted by a power source and a switch part. In response to an electrode selecting signal from the contact detecting unit 21, the switch part sequentially selects X electrodes 12, and the voltage applying unit 11a applies the reference voltage to the selected X electrodes 12 from the power source.

Further, the touch panel 10 includes a voltage meter 11b, which selectively measures voltages of Y electrodes 14 specified by electrode selecting signals from the contact detecting unit 21, and returns measured results to the contact detecting unit 21.

When the touch panel 10 is pressed by the user's finger or input pen, the X and Y electrodes 12 and 14 at the pressed position come into contact with each other, and become conductive. The reference voltage applied to the X electrode 12 is measured via the Y electrode 14 where the touch panel 10 is pressed. Therefore, when the reference voltage is detected as an output voltage of the Y electrode 14, the contact detecting unit 21 can identify the Y electrode 14, and the X electrode 12 which is applied the reference voltage. Further, the contact detecting unit 21 can identify the contact detector 10b which has been pressed by the user's finger or input pen on the basis of a combination of the X electrode 12 and Y electrode 14.

The contact detecting unit 21 repeatedly and quickly detects contact states of the X and Y electrodes 12 and 14, and accurately detects a number of the X and Y electrodes 12 and 14 which are simultaneously pressed, depending upon arranged intervals of the X and Y electrodes 12 and 14.

For instance, if the touch panel 20 is strongly pressed by the user's finger, a contact area is enlarged. The enlarged contact area means that a number of contact detectors 10b are pressed. In such a case, the contact detecting unit 21 repeatedly and quickly applies the reference voltage to X electrodes 12, and repeatedly and quickly measures voltages at Y electrodes 14. Hence, it is possible to detect the contact detectors 10b pressed at a time. The contact detecting unit 21 can detect a size of the contact area on the basis of detected contact detectors 10b.

In response to a command from the device control IC 23, the display driver 22 indicates one or more images of buttons, icons, keyboard, ten-keypad, mouse and so on which are used as input devices, i.e., user's interface. Light emitted by the backlight 6 passes through the LCD from a back side thereof, so that the images on the display unit 5 can be observed from the front side.

The device control IC 23 identifies an image of the key at the contact point on the basis of a key position on the virtual keyboard (indicated on the display unit 5) and the contact position and a contact area detected by the contact detecting unit 21. Information on the identified key is notified to the computer main unit 30.

The computer main unit 30 controls operations for the information received from the device control IC 23.

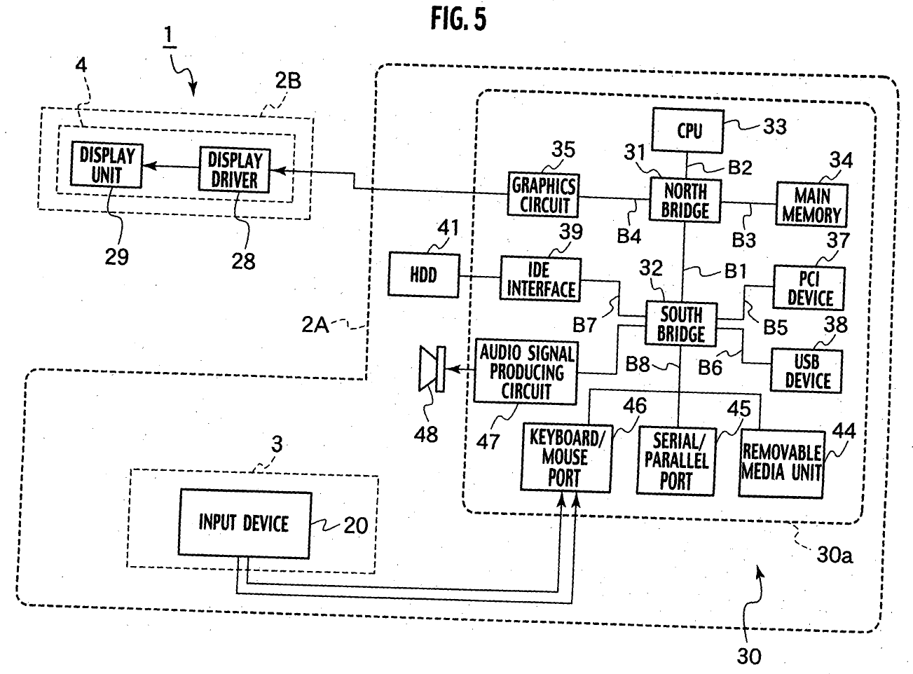

Referring to FIG. 5, in a motherboard 30a (functioning as the computer main unit 30), a north bridge 31 and a south bridge 32 are connected using a dedicated high speed bus B1. The north bridge 31 connects to a central processing unit 33 (called the “CPU 33”) via a system bus B2, and to a main memory 34 via a memory bus B3, and to a graphics circuit 35 via an accelerated graphics port bus B4 (called the “AGP bus B4”).

The graphics circuit 35 outputs a digital image signal to a display driver 28 of the display panel 4 in the upper housing 2B. In response to the received signal, the display driver 28 actuates the display panel 29. The display panel 29 indicates an image on a display panel (LCD) thereof. Further, the south bridge 32 connects to a peripheral component interconnect device 37 (called the “PCI device 37”) via a PCI bus B5, and to a universal serial bus device 38 (called the “USB device 38”) via a USB bus B6. The south bridge 32 can connect a variety of units to the PCI bus 35 via the PCI device 37, and connect various units to the USB device 38 via the USB bus B6.

Still further, the south bridge 32 connects to a hard disc device 41 (called the “HDD 41”) via an integrated drive electronics interface 39 (called the “IDE interface 39”) and via an AT attachment bus B7 (called the “ATA bus 37”). In addition, the south bridge 32 connects via a low pin count bus B8 (called the “LCP bus B8”) to a removable media device (magnetic disc device) 44, a serial/parallel port 45 and a keyboard/mouse port 46. The keyboard/mouse port 46 provides the south bridge 32 with a signal received from the input device 20 and indicating the operation of the keyboard or the mouse. Hence, the signal is transferred to the CPU 33 via the north bridge 31. The CPU 33 performs processing in response to the received signal.

The south bridge 32 also connects to an audio signal output circuit 47 via a dedicated bus. The audio signal output circuit 47 provides an audio signal to a speaker 48 housed in the computer main unit 30. Hence, the speaker 48 outputs variety of sounds.

The CPU 33 executes various programs stored in a hard disc of the HDD 41 and the main memory 34, so that images are shown on the display panel 29 of the display unit 4 (in the upper housing 2B), and sounds are output via the speaker 48 (in the lower housing 2A). Thereafter, the CPU 33 executes operations in accordance with the signal indicating the operation of the keyboard or the mouse from the input device 20. Specifically, the CPU 33 controls the graphics circuit 35 in response to the signal concerning the operation of the keyboard or the mouse. Hence, the graphics circuit 35 outputs a digital image signal to the display unit 5, which indicates an image corresponding to the operation of the keyboard or the mouse. Further, the CPU 33 controls the audio signal output circuit 47, which provides an audio signal to the speaker 48. The speaker 48 outputs sounds indicating the operation of the keyboard or the mouse.

The following describe how the input device 20 operates in order to detect contact states of the finger or input pen on the contact detecting layer 10a.

The contact detecting unit 21 (as a contact position detector) periodically detects a position where the object is in contact with the contact detecting layer 10a of the touch panel 10, and provides the device control IC 23 with the detected results.

The contact detecting unit 21 (as a contact strength detector) detects contact strength of the object on the contact detecting layer 10a. The contact strength may be represented by two, three or more discontinuous values or a continuous value. The contact detecting unit 21 periodically provides the device control IC 23 with the detected strength.

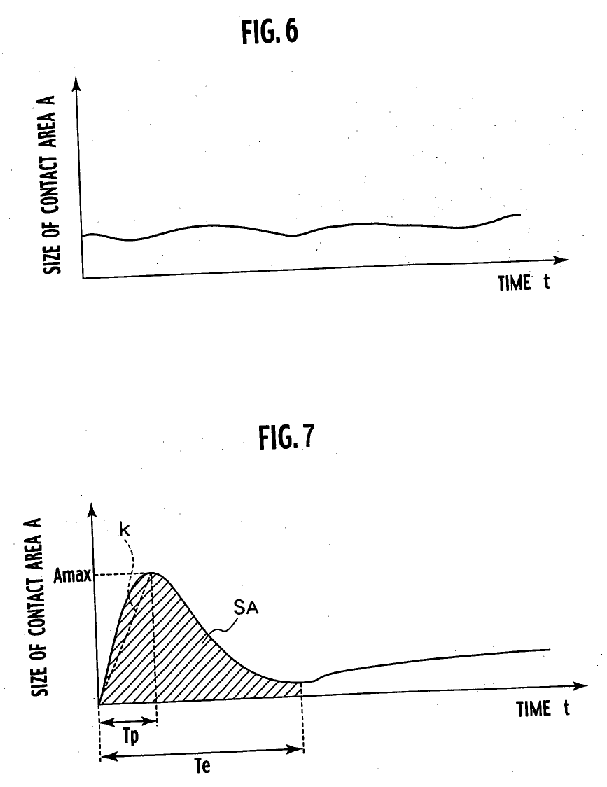

The contact strength can be detected on the basis of the sizes of the contact area of the object on the contact detecting layer 10a, or time-dependent variations of the contact area. FIG. 6 and FIG. 7 show variations of sizes of the detected contact area. In these figures, the ordinate and abscissa are dimensionless, and neither units nor scales are shown. Actual values may be used at the time of designing the actual products.

The variations of the contact area will be derived by periodically detecting data on the sizes of contacts between the object and the contact detector 10b using a predetermined scanning frequency. The higher the scanning frequency, the more signals will be detected in a predetermined time period. Resolutions can be more accurately improved with time. For this purpose, reaction speeds and performance of the devices and processing circuits have to be improved. Therefore, an appropriate scanning frequency will be adopted.

Specifically, FIG. 6 shows an example in which the object is simply in contact with the contact detecting layer 10a, i.e. the user simply places his or her finger without aim to key. The size of the contact area A do not change shapely.

On the contrary, FIG. 7 shows another example in which a size of the contact area A varies when a key is hit on the keyboard on the touch panel 10. In this case, the size of the contact area A is quickly increased from 0 or substantially 0 to a maximum, and then quickly is reduced.

The contact strength may be detected on the basis of a contact pressure of the object onto the contact detecting layer 10a, or time-dependent variations of the contact pressure. In this case, a sensor converting the pressure into an electric signal may be used as the contact detecting layer 10a.

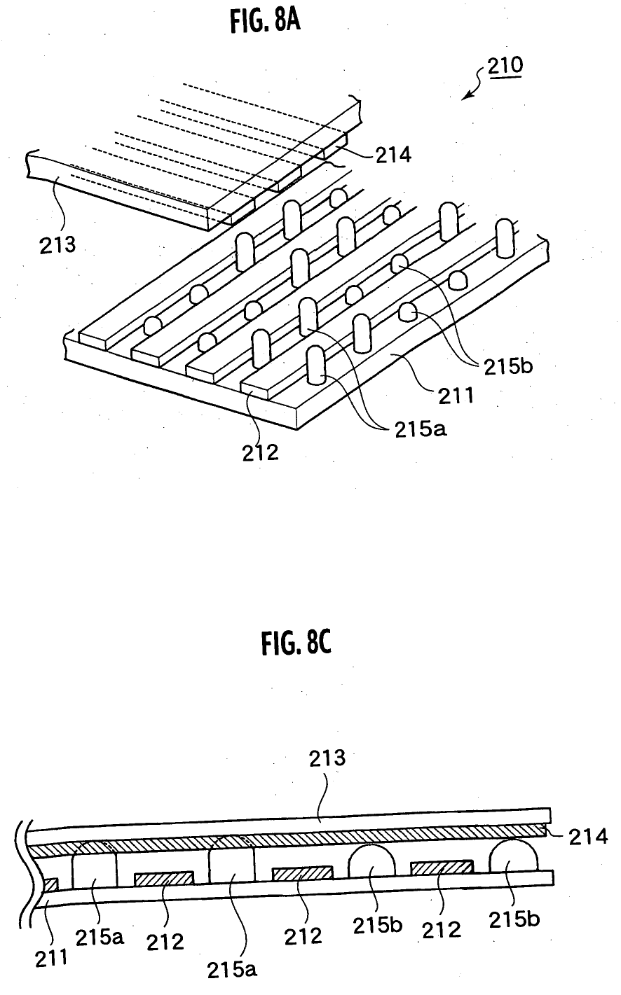

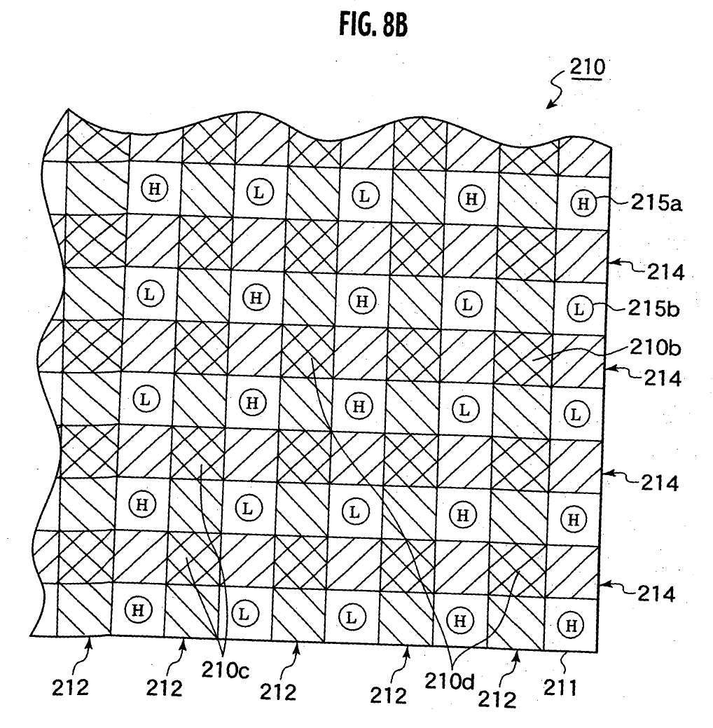

FIG. 8A and FIG. 8B show a touch panel 210 as a sensor converting the pressure into an electric signal.

Referring to these figures, the touch panel 210 includes a base 211 and a base 213. The base 211 is provided with a plurality of (i.e., n) transparent electrode strips 212 serving as X electrodes (called the “X electrodes 212”) and equally spaced in the direction X. The base 213 is provided with a plurality of (i.e., m) transparent electrode strips 214 serving as Y electrodes (called the “Y electrodes 214”) and equally spaced in the direction Y. The bases 211 and 213 are stacked with the X and Y electrodes 212 and 214 facing one another. Hence, (n×m) contact detectors 210b to 210d are present in the shape of a matrix at intersections of the X and Y electrodes 212 and 214.

Further, a plurality of convex spacers 215 are provided between the X electrodes 212 on the base 211, and have a height which is larger than a total thickness of the X and Y electrodes 212 and 214. The tops of the convex spacers 215 are in contact with the base 213 exposed between the Y electrodes 214.

Referring to FIG. 8A, in a dot spacer 215, four tall dot spacers 215a constitute one group, and four short dot spacers 215b constitute one group. Groups of the four tall dot spacers 215a and groups of the four short dot spacers-215b are arranged in a reticular pattern, as shown in FIG. 8B. The number of toll dot spacers 215a per group and that of short dot spacers 215b per group can be determined as desired.

Referring to FIG. 8C, the convex spacers 215 are sandwiched between the bases 211 and 213. Hence, X and Y electrodes 212 and 214 are not in contact with one another. Therefore, the contact detectors 210b to 210e are electrically in an off-state.

The X and Y electrodes 212 and 214 are in an on-state when the base 213 is flexed while the foregoing electrodes are not in contact with one another.

With the touch panel 210, the surface 213A which is opposite to the surface of the base 213 where the Y electrodes 214 are positioned is exposed as an input surface. When the surface 213A is pressed by the user's finger, the base 213 is flexed, thereby bringing the Y electrode 214 into contact with the X electrode 21².

If pressure applied by the user's finger is equal to or less than a first predetermined pressure, the base 213 is not sufficiently flexed, which prevents the X and Y electrodes 214 and 212 from coming into contact with each other.

Conversely, when the applied pressure is above the first predetermined pressure, the base 213 is sufficiently flexed, so that a contact detector 210b surrounded by four low convex spacers 215b (which are adjacent to one another without via the Y and X electrodes 214 and 212) remains in the on-state. The contact detectors 210c and 210d surrounded by two or more high convex spacers 215a remain in the off-state.

If the applied pressure is larger than a second predetermined pressure, the base 213 is further flexed, the contact detector 210c surrounded by two low convex spacers 215b is in the on-state. However, the contact detector 210d surrounded by four high convex spacers 215a remain in the off-state.

Further, if the applied pressure is larger than a third predetermined pressure which is larger than the second pressure, the base 213 is more extensively flexed, so that the contact detector 210d surrounded by four high convex spacers 215a is in the on-state.

The three contact detectors 210b to 210d are present in the area pressed by the user's finger, and function as sensors converting the detected pressures into three kinds of electric signals.

With the portable microcomputer including the touch panel 210, the contact detecting unit 21 detects which contact detector is in the on-state.

For instance, the contact detecting unit 21 detects a contact detector, which is existing in center of a group of adjacent contact detectors in the on-state, as a position where the contact detecting surface 10a is pressed.

Further, the contact detecting unit 21 ranks the contact detectors 210b to 210d in three grades, and a largest grade is output as pressure, among a group of adjacent contact detectors in the on-state.

The contact detecting unit 21 detects a contact area and pressure distribution as follows.

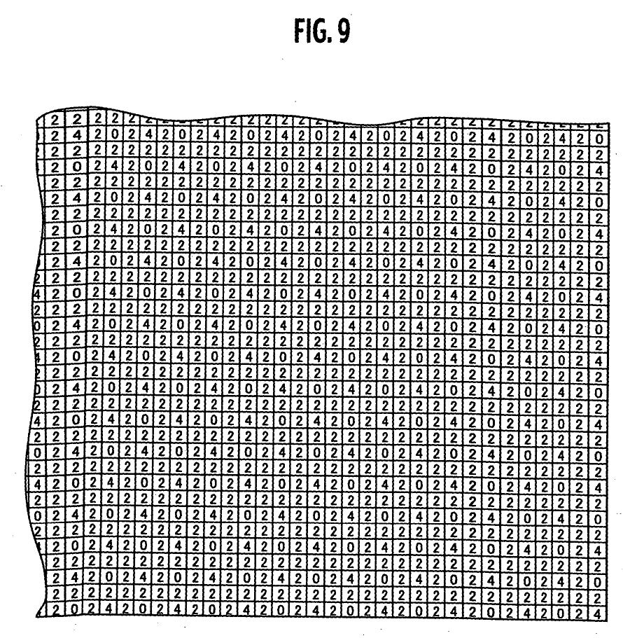

When the low and high convex spacers 215b and 215a shown in FIG. 8B are arranged as shown in FIG. 9, each contact detector 210 is surrounded by four convex spacers. In FIG. 9, numerals represent the number of the high convex spacers 215a at positions corresponding to the contact detectors 210a to 210d.

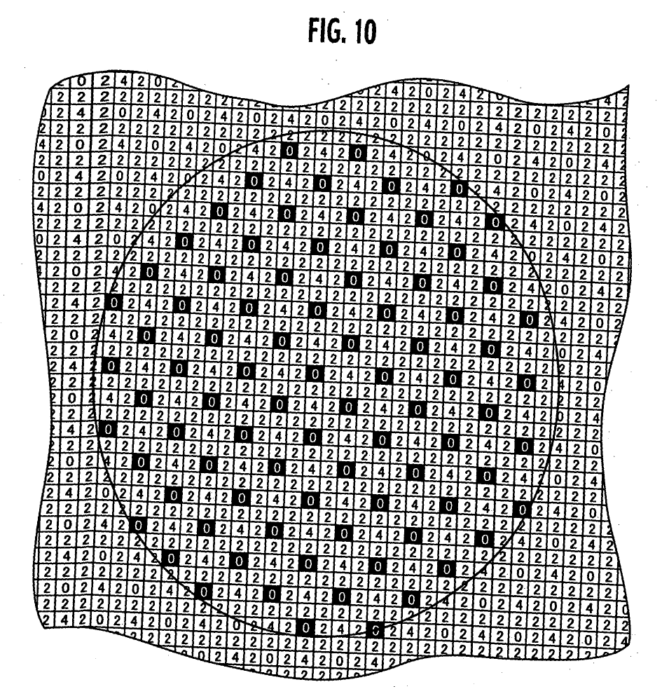

In FIG. 10, an oval shows an area contacted by the user's finger, and is called the “outer oval”.

When a surface pressure of the contact area (i.e., pressure per unit area) is simply enough to press contact detectors shown by “0”, the contact detecting unit 21 detects that only contact detectors “0” (i.e., the contact detectors 210b shown in FIG. 8B) are pressed.

If much stronger pressure is applied to an area whose size is the same as that of the outer oval compared to the pressure shown in FIG. 9, the contact detecting unit 21 detects contact detectors “2” existing in an oval inside (called the “inner oval”) the outer oval, i.e., contact detectors 210c shown in FIG. 8B are pressed.

The larger the pressure, the larger the outer oval as described with reference to the operation principle of the embodiment. However, it is assumed that the outer oval has a constant size in order to explain more easily.

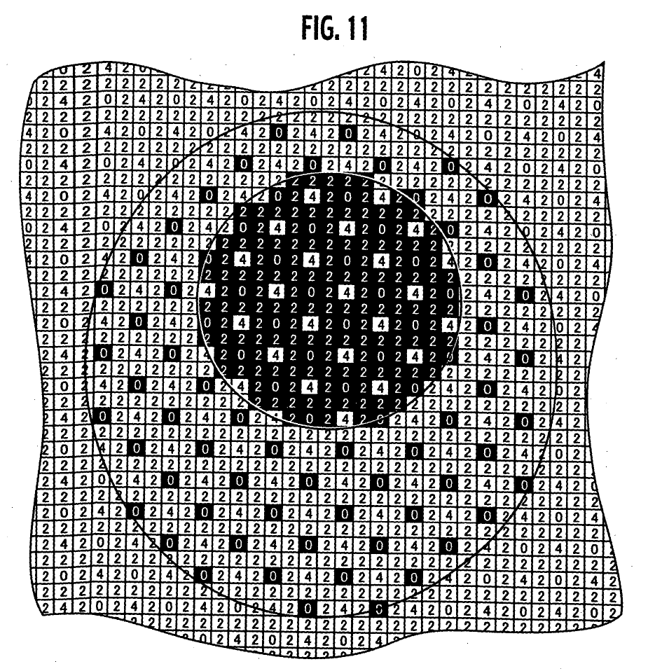

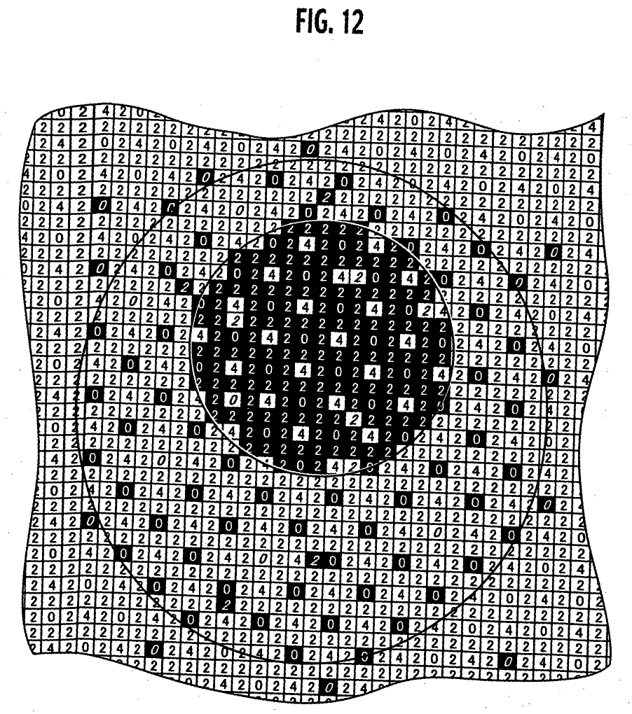

However, the surface pressure is not always actually distributed in the shape of an oval as shown in FIG. 11. In FIG. 12, some contact detectors outside the outer oval may be detected to be pressed, and some contact detectors “O” or “2” inside the inner oval may not be detected to be pressed. Those exception are described in italic digits in FIG. 12. In short, contact detectors “O” and “2” are mixed near a border of the outer and inner ovals. The border, size, shape or position of the outer and inner ovals are determined so as to reduce errors caused by these factors. In such a case, the border of the outer and inner ovals may be complicated in order to assure flexibility. However, the border is actually shaped with an appropriate radius of curvature. This enables the border to have a smoothly varying contour and is relatively free from errors. The radius of curvature determined through experiments, machine learning algorithm or the like. Objective functions are a size of an area surrounded by the outer oval and inner oval at the time of keying, a size of an area surrounded by the inner oval and an innermost oval, and a time-dependent keying identifying error rate. A minimum the radius of curvature is determined in order to minimize the foregoing parameters.

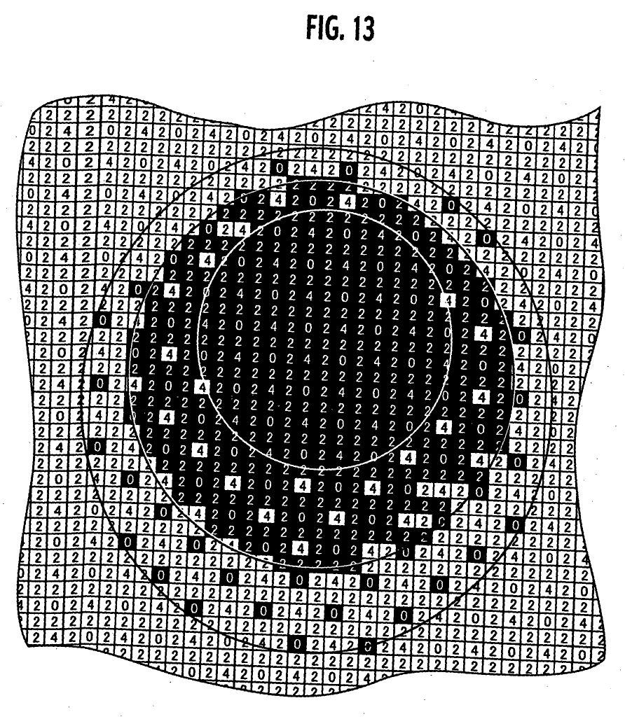

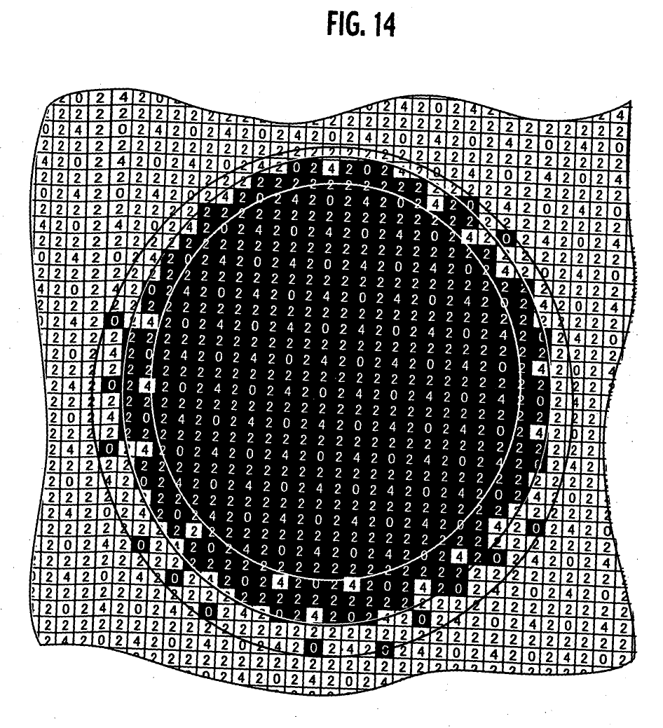

The border determining method mentioned above is applicable to the cases shown in FIG. 10, FIG. 11, FIG. 13 and FIG. 14. In FIG. 13 and FIG. 11, crossing the border of the contact detectors or contact detectors existing across the border are not shown.

FIG. 13 shows that much stronger pressure than that shown in FIG. 11 is applied. In this case, an innermost oval appears inside the inner oval. In the second inner oval, the contact detectors shown by “0”, “2” and “4” are detected to be pressed, i.e., the contact detectors 210b, 210c and 210d shown in FIG. 8B are pressed.

Referring to FIG. 14, the sizes of the inner oval and innermost oval are enlarged. This means that pressure which is further larger than that of FIG. 13 is applied.

It is possible to reliably detect whether the user intentionally or unintentionally depresses a key or keys by detecting time dependent variations of the sizes of the ovals and time-dependent variations of a size ratios of the ovals, as shown in FIG. 10, FIG. 11, FIG. 13 and FIG. 14.

For instance, the sensor converting the pressure into the electric signal is used to detect the contact pressure of the object onto the contact detecting surface 10a or contact strength on the basis of time-dependent variations of the contact pressure. If the ordinates in FIG. 6 and FIG. 7 are changed to “contact pressure”, the same results will be obtained with respect to “simply placing the object” and “key hitting”.

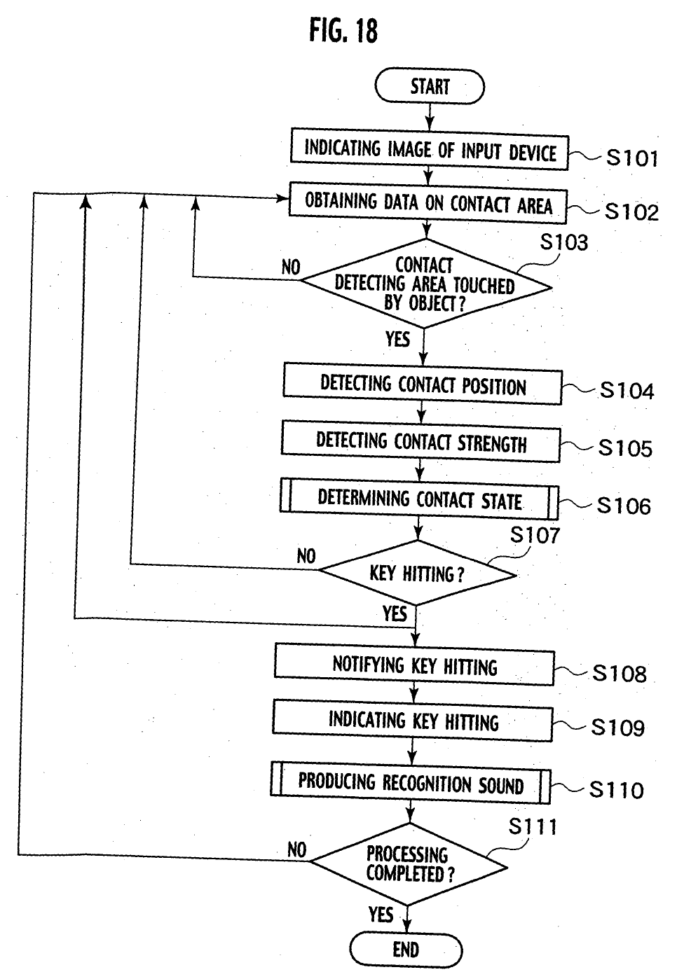

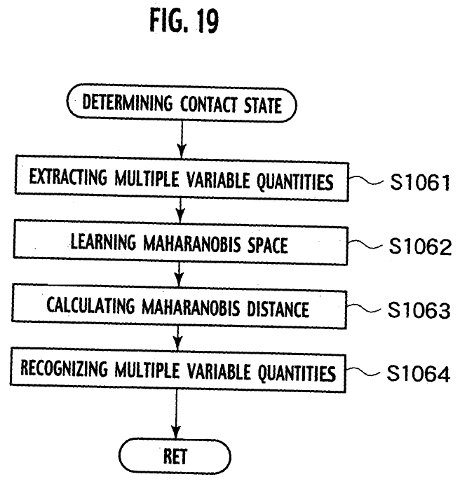

The device control IC 23 (as a determining section) receives the contact strength detected by the contact detecting unit 21, extracts a feature quantity related to the contact strength, compares the extracted feature quantity or a value calculated based on the extracted feature quantity with a predetermined threshold, and determines a contact state of the object. The contact state may be classified into “non-contact”, “contact” or “key hitting”. “Non-contact” represents that nothing is in contact with an image on the display unit 5; “contact” represents that the object is in contact with the image on the display unit 5; and “key hitting” represents that the image on the display unit 5 is hit by the object. Determination of the contact state will be described later in detail with reference to FIG. 18 and FIG. 19.

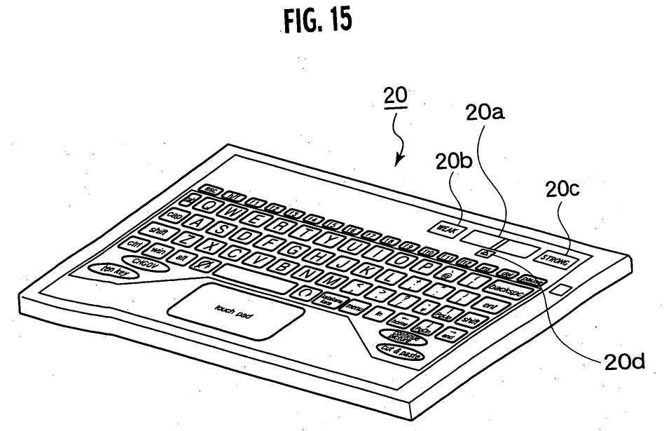

The thresholds used to determine the contact state are adjustable. For instance, the device control IC23 indicates a key 20b (WEAK), a key 20c (STRONG), and a level meter 20a, which shows levels of the thresholds. Refer to FIG. 15. It is assumed here that the level meter 20a has set certain thresholds for the states “contact” and “key hitting” beforehand. If the user gently hits an image, such key-hitting is often not recognized. In such a case, the “WEAK” button 20b is pressed. The device control IC 23 determines whether or not the “weak” button 20b is pressed, on the basis of the position of the button 20b on the display panel 5, and the contact position detected by the contact detecting unit 21. When the button 20b is recognized to be pressed, the display driver 22 is actuated in order to move a value indicated on the level meter 20a to the left, thereby lowering the threshold. In this state, the image is not actually pushed down, but pressure is simply applied onto the image. For the sake of simplicity, the term “key hitting” denotes that the user intentionally pushes down the image. Alternatively, the indication on the level meter 20a may be changed by dragging a slider 20d near the level meter 20a.

The device control IC 23 (as a notifying section) informs the motherboard 30a (shown in FIG. 5) of the operated keyboard or mouse as the input device and the contact state received from the contact detecting unit 21. In short, the position of the key pressed in order to input information, or the position of the key on which the object is simply placed is informed to the motherboard 30a.

The device control IC 23 (as a display controller) shown in FIG. 4 changes the indication mode of the image on the display unit 5 in accordance with the contact state (“non-contact”, “contact” or “key hitting”) of the object on the contact detecting layer 10a. Specifically, the device control IC 23 changes brightness, colors profiles, patterns and thickness of profile lines, blinking/steady lighting, blinking intervals of images in accordance with the contact state.

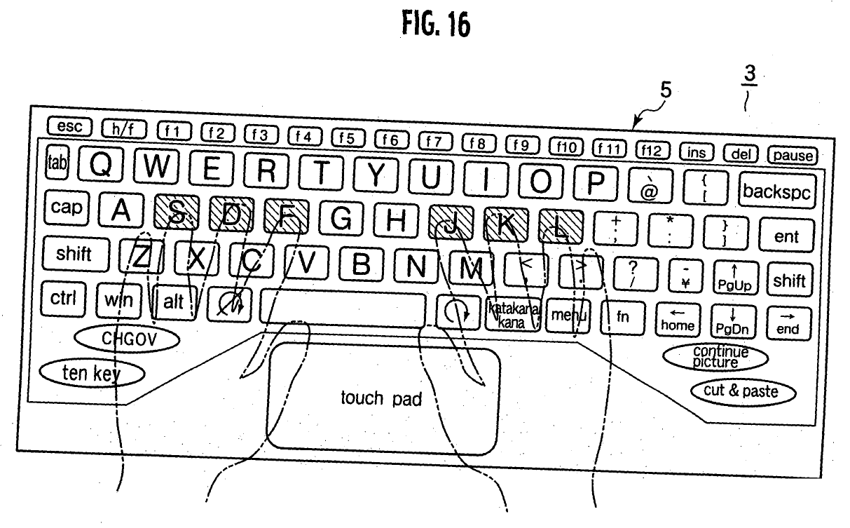

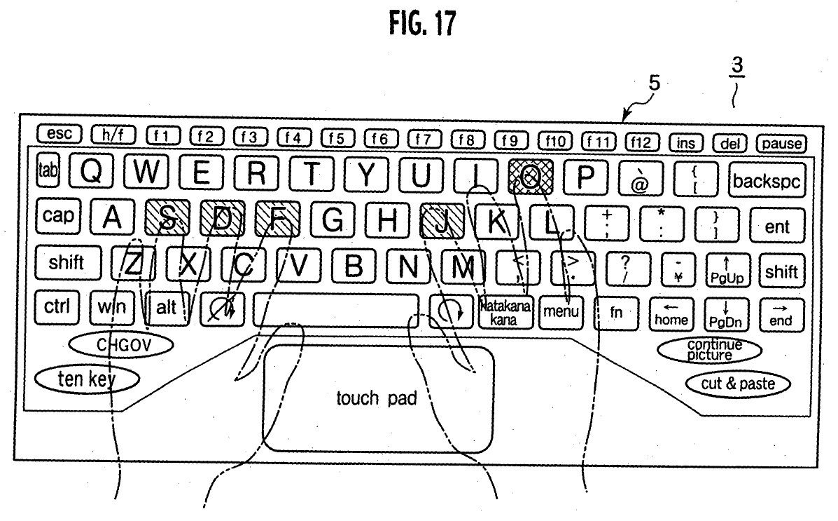

It is assumed here that the display unit 5 indicates the virtual keyboard, and the user is going to input information. Refer to FIG. 16. The user places his or her fingers at the home positions in order to start to key hitting. In this state, the user's fingers are on the keys “S”, “D”, “C”), “J”, “K” and “L”. The device control IC 23 lights the foregoing keys in yellow, for example. The device control IC lights the remaining non-contact keys in blue, for example. In FIG. 17, when the user hits the key “O”, the device control IC 23 lights the key “O” in red, for example. The keys “S”, “D”, “F” and “J” remain yellow, which means that the user's fingers are on these keys.

If it is not always necessary to identify “non-contact”, “contact” and “key hitting”, the user may select the contact state in order to change the indication mode.

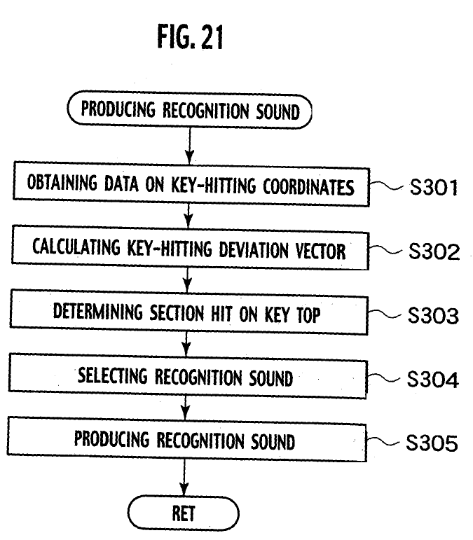

Further, the device control IC 23 functions as a sound producing section, decides a predetermined recognition sound in accordance with the contact state on the basis of the relationship between the position detected by the contact detecting section 21 and the position of the image of the virtual keyboard or mouse, controls the speaker driver 25, and issues the recognition sound via the speaker 26. For instance, it is assumed that the virtual keyboard is indicated on the display unit 5, and that the user may hit a key. In this state, the device control IC 23 calculates a relative position of the key detected by the contact detecting unit 21 and the center of the key indicated on the display unit 5. This calculation will be described in detail later with reference to FIG. 21 to FIG. 23.

When key hitting is conducted and a relative distance between an indicated position of a hit key and the center thereof is found to be larger than a predetermined value, the device control IC 23 actuates the speaker driver 25, thereby producing a notifying sound. The notifying sound may have a tone, time interval, pattern or the like different from the recognition sound issued for the ordinary “key hitting”.

It is assumed here that the user enters information using the virtual keyboard on the display unit 5. The user puts the home position on record beforehand. If the user places his or her fingers on keys other than the home position keys, the device control IC 23 recognizes that the keys other than the home position keys are in contact with the user's fingers, and may issue another notifying sound different from that issued when the user touches the home position keys (e.g. a tone, time interval or pattern).

A light emitting unit 27 is disposed on the input device, and emits light in accordance with the contact state determined by the device control IC 23. For instance, when it is recognized that the user places his or her fingers on the home position keys, the device control IC 23 makes the light emitting unit 27 luminiferous.

The memory 24 stores histories of contact positions and contact strength of the object for a predetermined time period. The memory 24 may be a random access memory (RAM), a nonvolatile memory such as a flash memory, a magnetic disc such as a hard disc or a flexible disc, an optical disc such as a compact disc, an IC chip, a cassette tape, and so on.

The following describe how to store various information processing programs. The input device 20 stores in the memory 24 information processing programs, which enable the contact position detecting unit 21 and device control IC 23 to detect contact positions and contact strength, and to determine contact states. The input device 20 includes an information reader (not shown) in order to store the foregoing programs in the memory 24. The information reader obtains information from a magnetic disc such as a flexible disc, an optical disc, an IC chip, or a recording medium such as a cassette tape, or downloads programs from a network. When the recording medium is used, the programs may be stored, carried or sold with ease.

The input information is processed by the device control IC 23 and so on which execute the programs stored in the memory 24. Refer to FIG. 18 to FIG. 23. Information processing steps are executed according to the information processing programs.

It is assumed that the user inputs information using the virtual keyboard shown on the display unit 5 of the input unit 3.

The information is processed in the steps shown in FIG. 18. In step S101, the input device 20 shows the image of an input device (i.e., the virtual keyboard) on the display unit 5. In step S102, the input device 20 receives data of the detection areas on the contact detecting layer 10a of the touch panel 10, and determines whether or not there is a detection area in contact with an object such as a user's finger. When there is no area in contact with the object, the input device 20 returns to step S102. Otherwise, the input device 20 advances to step S104.

The input device 20 detects the position where the object is in contact with the contact detecting layer 10a in step S104, and detects contact strength in step S105.

In step S106, the input device 20 extracts' a feature quantity corresponding to the detected contact strength, compares the extracted feature quantity or a value calculated using the feature quantity with a predetermined threshold, and identifies a contact state of the object on the virtual keyboard. The contact state is classified into “non-contact”, “contact” or “key hitting” as described above. FIG. 7 shows the “key hitting”, i.e., the contact area A is substantially zero at first, but abruptly increases. This state is recognized as the “key hitting”. Specifically, a size of the contact area is extracted as the feature quantity as shown in FIG. 6 and FIG. 7. An area velocity or an area acceleration is derived using the size of the contact area, i.e., a feature quantity ΔA/Δt or Δ2A/Δt² is calculated. When this feature quantity is above the threshold, the contact state is determined to be the “key hitting”.

The threshold for the feature quantity ΔA/Δt or Δ2A/Δt² depends upon a user or an application program in use, or may gradually vary with time even if the same user repeatedly operates the input unit. Instead of using a predetermined and fixed threshold, the threshold will be learned and re-calibrated at proper timings in order to improve accurate recognition of the contact state.

In step S107, the input device 20 determines whether or not the key hitting is conducted. If not, the input device 20 returns to step S102, and obtains the data of the detection area. In the case of the “key hitting”, the input device 20 advances to step S108, and notifies the computer main unit 30 of the “key hitting”. In this state, the input device 20 also returns to step S102 and obtains the data of the detection area for the succeeding contact state detection. The foregoing processes are executed in parallel.

In step S109, the input device 20 changes the indication mode on the virtual keyboard in order to indicate the “key hitting”, e.g., changes the brightness, color, shape, pattern or thickness of the profile line of the hit key, or blinking/steady lighting of the key, or blinking/steady lighting interval. Further, the input device 20 checks lapse of a predetermined time period. If not, the input device 20 maintains the current indication mode. Otherwise, the input device 20 returns the indication mode of the virtual keyboard to the normal state. Alternatively, the input device 20 may judge whether or not the hit key blinks the predetermined number of times.

In step S110, the input device 20 issues a recognition sound (i.e., an alarm). This will be described later in detail with reference to FIG. 21.

FIG. 19 shows the process of the “key hitting” in step S106.

First of all, in step S1061, the input device 20 extracts multivariate data (feature quantities). For instance, the following are extracted on the basis of the graph shown in FIG. 7: a maximum size Aₘₐₓ of the contact area, a transient size Sa of the contact area A derived by integrating a contact area A, a maximum time T_{P} to accomplish the maximum size Aₘₐₓ of the contact area, and a total period of time Tₑ of the key hitting from the beginning to end. A rising gradient k=Aₘₐₓ/T_{P} and so on are calculated on the basis of the foregoing feature quantities.

The foregoing qualitative and physical characteristics of the feature quantities show the following tendencies. The thicker the user's fingers and stronger the key hitting, the larger the maximum size Aₘₐₓ of the contact area. The stronger the key hitting, the larger the transient size Sₐ of the contact area A. The more soft the user's fingers and the stronger and slower the key hitting, the longer the time until the maximum size of the contact area T_{P}. The slower the key hitting and the more soft the user's fingers, the longer the total period of time Tₑ. Further, the quicker and stronger the key hitting and the harder the user's fingers, the larger the rising gradient k=Aₘₐₓ/T_{P}.

The feature quantities are derived by averaging values of a plurality of key-hitting times of respective users, and are used for recognizing the key hitting. Data on only the identified key hitting are accumulated, and analyzed. Thereafter, thresholds are set in order to identifying the key hitting. In this case, the key hitting canceled by the user are counted out.

The feature quantities may be measured for all of the keys. Sometimes, the accuracy of recognizing the key hitting may be improved by measuring the feature quantities for every finger, every key, or every group of keys.

Separate thresholds may be determined for the foregoing variable quantities. The key hitting may be identified on the basis of a conditional branch, e.g., when one or more variable quantities exceed the predetermined thresholds. Alternatively, the key hitting may be recognized using a more sophisticated technique such as the multivariate analysis technique.

For example, a plurality of key hitting times are recorded. Mahalanobis spaces are learned on the basis of specified sets of multivariate data. A Mahalanobis distance of the key hitting is calculated using the Mahalanobis spaces. The shorter the Mahalanobis distance, the more accurately the key hitting is identified. Refer to “The Mahalanobis-Taguchi System”, ISBN: 0-07-136263-0, McGraw-Hill, and so on.

Specifically, in step S1062 shown in FIG. 1-9, an average and a standard deviation are calculated for each variable quantity in multivariate data. Original data are subject to z-transformation using the average and standard deviation (this process is called “standardization”). Then, correlation coefficients between the variable quantities are calculated to derive a correlation matrix. Sometimes, this learning process is executed only once when initial key hitting data are collected, and is not updated. However, if a user's key hitting habit is changed, if the input device is mechanically or electrically aged, or if the recognition accuracy of the key hitting lowers for some reason, relearning will be executed in order to improve the recognition accuracy.

In step S1063, the Mahalanobis distance of key hitting data to be recognized is calculated using the average, standard deviation and a set of the correlation matrix.

The multivariate data (feature quantities) are recognized in step S1064. For instance, when the Mahalanobis distance is smaller than the predetermined threshold, the object is recognized to be in the “key hitting” state.

When the algorithm in which the shorter the Mahalanobis distance, the more reliably the key hitting may be recognized is utilized, the user identification can be further improved compared with the case where the feature quantities are used as they are for the user identification. This is because when the Mahalanobis distance is utilized, the recognition, i.e., pattern recognition, is conducted taking the correlation between the learned variable quantities into consideration. Even if the peak value Aₘₐₓ is substantially approximate to the average of the key hitting data but the maximum time T_{P} is long, a contact state other than the key hitting will be accurately recognized.

In this embodiment, the key hitting is recognized on the basis of the algorithm in which the Mahalanobis space is utilized. It is needless to say that a number of variable quantities may be recognized using other multivariate analysis algorithms.

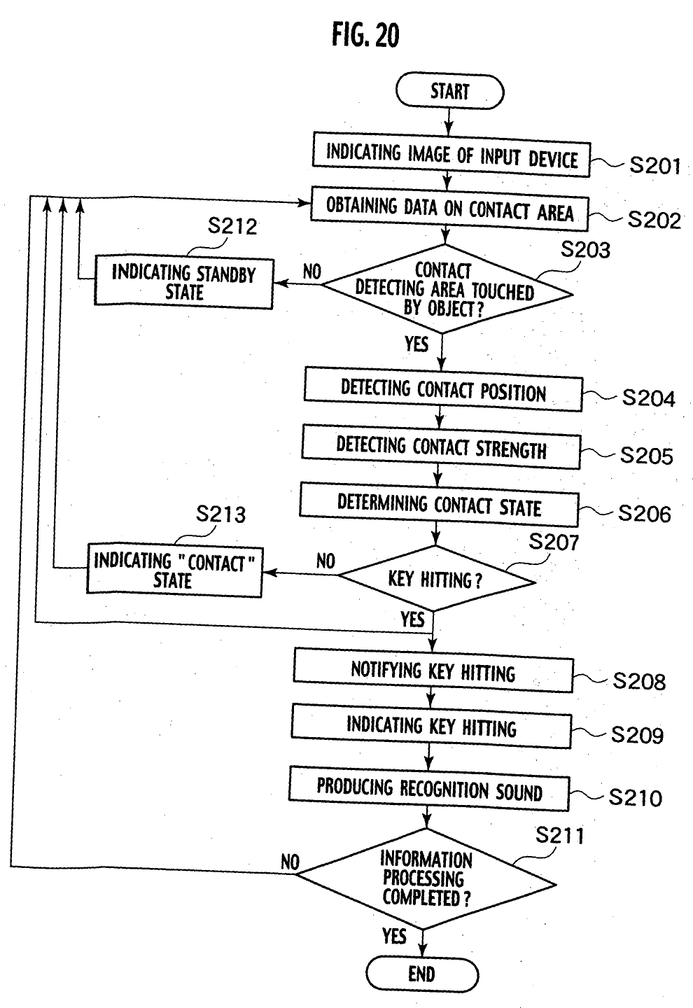

The following describe a process to change indication modes for indicating the “non-contact” and “contact” states with reference to FIG. 20.

Steps S201 and S202 are the same as steps S101 and S102 shown in FIG. 18, and will not be referred to.

In step 203, the input device 20 determines whether or not the contact detecting layer 10a is touched by the object. If not, the input device 20 advances to step S212. Otherwise, the input device 20 goes to step S204. In step S212, the input device 20 recognizes that the keys are in the “non-contact” state on the virtual keyboard, and changes the key indication mode (to indicate a “standby state”). Specifically, the non-contact state is indicated by changing the brightness, color, shape, pattern or thickness of a profile line which is different from those of the “contact” or “key hitting” state. The input device 20 returns to step S202, and obtains data on the detection area.

Steps S204 to S206 are the same as steps S104 to S106, and will not be described here.

The input device 20 advances to step S213 when no key hitting is recognized in step S207. In step S213, the input device 20 recognizes that the object is in contact with a key on the virtual keyboard, and changes the indication mode to an indication mode for the “contact” state. The input device 20 returns to step S202, and obtains data on the detected area. When the key hitting is recognized, the input device 20 advances to step S208, and then returns to step S202 in order to recognize a succeeding state, and receives data on a detection area.

Steps S208 to S211 are the same as steps S108 to S111, and will not be described here.

In step S110 (shown in FIG. 18), the alarm is produced if the position of the actually hit key differs from an image indicated on the input device (i.e., the virtual keyboard). Refer to FIG. 21.

In step S301, the input device 20 acquires a key hitting standard coordinate (e.g., barycenter coordinate which is approximated based on a coordinate group of the contact detector 10b of the hit key).

Next, in step S302, the input device 20 compares the key hitting standard coordinate and the standard coordinate (e.g., a central coordinate) of the key hit on the virtual keyboard. The following is calculated; a deviation between the key hitting standard coordinate and the standard coordinate (called the “key-hitting deviation vector”), i.e., the direction and length on x and y planes extending between the key hitting standard coordinate and the standard coordinate of the hit key.

In step S303, the input device 20 identifies at which section the coordinate of the hit key is present on each key top on the virtual keyboard.

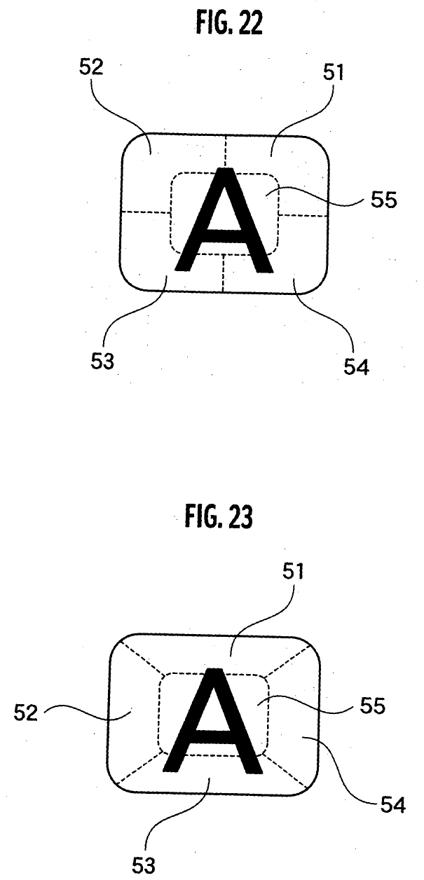

The key top may be divided into two, or into five sections as shown in FIG. 22 and FIG. 23. The user may determine the sections on the key top. The sections 55 shown in FIG. 22 and FIG. 23 are where the key is hit accurately.

The input device 20 determines a recognition sound on the basis of the recognized section. Recognition sounds having different tones, time intervals or patterns are used for the sections 51 to 55 shown in FIG. 22 and FIG. 23.

Alternatively, the input device 20 may change the recognition sounds on the basis of the length of the key-hitting deviation vector. For instance, the longer the key hitting deviation vector, the higher pitch the recognition sound has. The intervals or tones may be changed in accordance with the direction of the key hitting deviation vector.

If the user touches across two sections of one key top, an intermediate sound may be produced in order to represent two sections. Alternatively, the inner sound may be produced depending upon respective sizes of contacted sections. A sound may be produced for a larger section.

In step S305, the input device 20 produces the selected recognition sound at a predetermined volume. The input device 20 checks the elapse of a predetermined time period. If not, the recognition sound will be continuously produced. Otherwise, the input device 20 stops the recognition sound.

With respect to step S304, the different recognition sounds are provided for the sections 51 to 55. Alternatively, the recognition sound for the section 55 may be different from the recognition sounds for the sections 51 to 54. For instance, when the section 55 is hit, the input device 20 recognizes the proper key hitting, and produces the recognition sound which is different from the recognition sounds for the other sections. Alternatively, no sound will be produced in this case.

The user may determine a size or shape of the section 55 as desired depending upon its percentage or a ratio on a key top. Further, the section 55 may be automatically determined based on a hit ratio, or a distribution of x and y components of the key hitting deviation vector.

Alternatively, a different recognition sound may be produced for the sections 51 to 54 depending upon whether the hit part is in or out of the section 55.

The sections 55 of all of the keys may be independently or simultaneously adjusted, or the keys may be divided into a plurality of groups, each of which will be adjusted individually. For instance, key hitting deviation vectors of the main keys may be accumulated in a lump. Shapes and sizes of such keys may be simultaneously changed.

In the first embodiment, the input device 20 uses the information processing method and program, the contact detecting unit 21 (as the contact position and strength detecting sections) and the device control IC 23 (functioning as the determining section), and detects whether or the user's fingers are simply placed on the contact detecting layer 10a of the touch panel, or the user's fingers are intentionally placed on the contact detecting layer 10a in order to enter information. The feature quantities related to the contact strength are used for this purpose.

Further, it is possible to accurately detect the contact strength on, the basis of the size of the contact area, compared with a case in which the contact state is detected on the basis of a pressure and strength of the key hitting when a conventional pressure sensor type touch panel is used.

When an infrared ray type or an image sensor type touch panel of the related art is used, only a size or a shape of a contact area is detected, so that it is difficult to distinguish “key hitting” and “contact”. The input device 20 of the first embodiment can detect the contact state of the object very easily and accurately.

It is assumed here that an input pen which is relatively hard and smaller than the finger is brought into contact with the contact detecting layer. In this case, the size of the contact area is very small and remains substantially unchanged regardless of the contact pressure. However, the contact strength of the input pen can be reliably detected by estimating time-dependent variations of the size of the contact area.

Up to now, it is very difficult to quickly recognize a plurality of hit keys. The input device 20 of the first embodiment can accurately recognize the hit keys and keys on which the user's fingers are simply placed. Therefore, even when an adept user hits keys very quickly, i.e., a number of keys are hit in an overlapping manner with minute time intervals, the contact states of the hit keys can be accurately recognized.

The device control IC 23 (as the determining section) compares the feature quantities related to the contact strength or values (calculated on the basis of the feature quantities) with the predetermined threshold, which enables the contact state to be recognized. The user may adjust the thresholds in accordance with his or her key hitting habit. If a plurality of users operate the same machine, the device control IC 23 can accurately recognize the contact states taking the users' key hitting habits into consideration. Further, if a user keeps on operating keys for a while, key hitting strength will be changed. In such a case, the user can adjust the threshold as desired in order to maintain a comfortable use environment. Still further, thresholds are stored for individual login users, and then the thresholds will be used for the respective users as initial value.

The device control IC 23 (as the display controller) and the display unit 5 can change the indication mode of the image of an input device in accordance with the contact state. For instance, when the virtual keyboard is indicated, the “non-contact”, “contact” or “key hitting” state of the user's fingers can be easily recognized. This is effective in assisting the user to become accustomed to the input device 20. The “contact” state is shown in a manner different from the “non-contact” and “key hitting” states, which enables the user to know whether or not the user's fingers are on the home position keys, and always to place the fingers on the home position.

The brightness of the keys is variable with the contact state, which enables the use of the input device 20 in a dim place. Further, colorful and dynamic indications on the image of an input device will offer side benefits to the user, e.g., joy of using the input device 20, sense of fun, love of possession, feeling of contentment, and so on.

The combination of the input device 20, device control IC 23 (as the announcing section) and speaker 26 can issue the recognition sound on the basis of the relationship between the contact position of the object and the position of the image on the input device 20. This enables the user to know repeated typing errors or an amount of deviation from the center of each key. The user can practice in order to reduce typing errors, and become skillful.

The input device 20 and the device control IC 23 (as the communicating section) notifies the contact state to devices which actually process the information in response to the signal from the input device. For instance, when the user's fingers are placed on the home position, this state will be informed to the terminal device.

The light emitting unit 27 of the input device 0.20 emits light in accordance with the contact state of the object on the contact detecting layer 10a (FIG. 2). For instance, the user can see and recognize that his or her fingers are on the home position where the keys emit light.

### Second Embodiment

In this embodiment, the display unit 5 shows the virtual keyboard as the input device. An input device 60 detects whether keys are hit by a user's right or left hand.

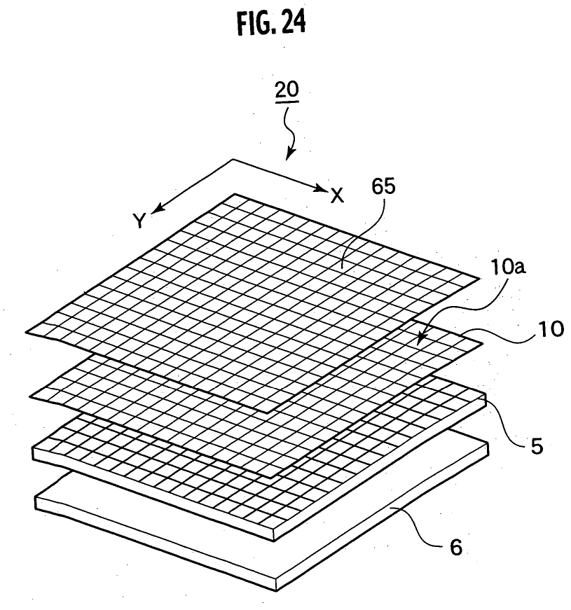

Referring to FIG. 24, the input device 60 includes a touch panel 10, display unit 5, and backlight 6. The touch panel 10 includes a detecting layer 10a and a resistance detecting layer 65 on the detecting layer 10a. The touch panel 10, display unit 5 and backlight 6 are the same as those in the first embodiment, and will not be described here.

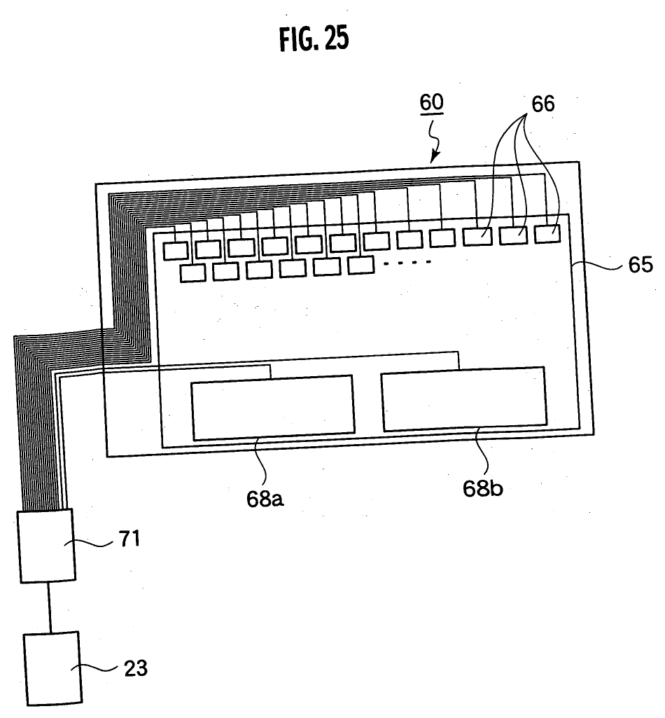

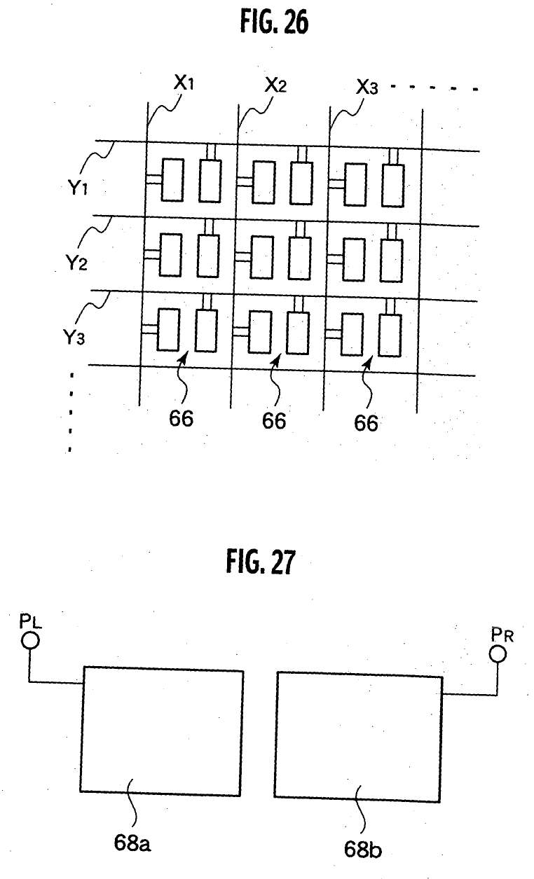

Referring to FIG. 25, the resistance detecting layer 65 includes: key detecting elements 66 corresponding to the positions of the keys on the virtual keyboard; a left palm detecting electrode 68a; and a right palm detecting electrode 68b, all of which are arranged on a printed wiring pattern made of a transparent conductive film. The transparent conductive film is structured similarly to those generally used for a variety of displays such as LCD. The resistance detecting layer 65 has interconnections to a resistance detecting unit 71, and outputs a detection signal. Each key detecting element 66 is connected to the resistance detecting unit 71. FIG. 26 shows the transparent conductive film in an enlarged scale. When the object comes into contact with one key detecting element 66, minute currents flow to wirings X₁ to Xₙ, and Y₁ to Yₘ. Hence, the resistance detecting unit 71 detects that the object is brought into contact.

If the touch panel 10 is of an electric resistance type, contact/key hitting state detecting elements includes external electric wirings (X₁ to Xₙ, and Y₁ to Yₘ). These wirings may be used for the “contact” or “key hitting” state detection. Further, if the touch panel 10 optically recognizes the “key hitting”, the resistance detecting layer 65 may be laminated on a contact detecting layer.

Referring to FIG. 27 when the object comes into contact with the left palm detecting electrode 68a, the minute current flows to a left contact P_{L} from the left palm detecting electrode 68a. On the other hand, when the object comes into contact with the right palm detecting electrode 68b, the minute current flows to a right contact P_{R} from the left palm detecting electrode 68b.

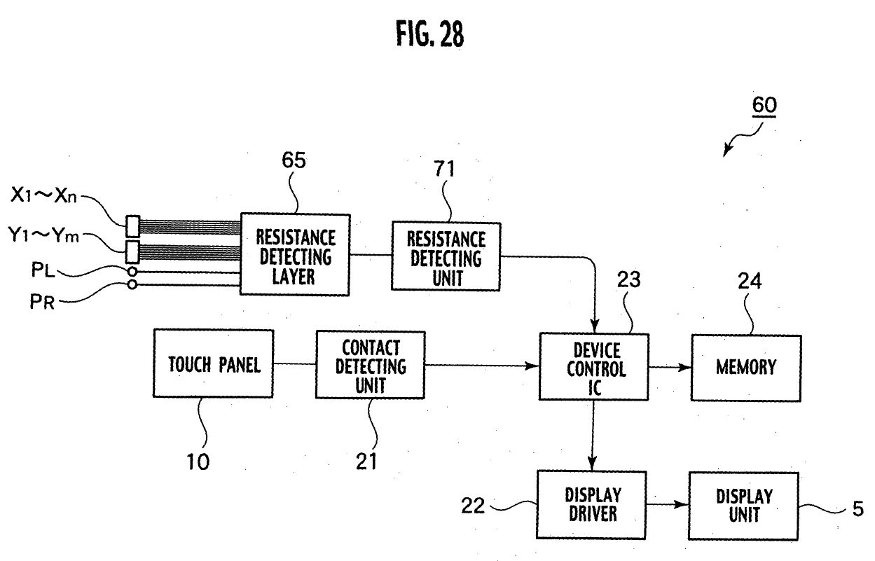

In FIG. 28, the input device 60 includes the resistance detecting layer 65, resistance detecting unit 71, touch panel 10, contact detecting unit 21, device control IC 23, memory 24, display driver 22, and display unit 5. The contact detecting unit 21 is the same as that used in the first embodiment, and is not described here.

The resistance detecting unit 71 (as a left/right palm detecting section) detects which left or right hand is used to hit a key on the virtual keyboard. The resistance detecting layer 65 is connected via its one end to the wirings (X₁ to Xₙ, and Y₁ to Yₘ) extending from the key detecting element 66, and to the contacts P_{L} and P_{R} extending from the left palm detecting electrode 68a and the right palm detecting electrode 68b, respectively. If a certain key detecting element 66 is recognized to be in the contact state, the resistance detecting unit 71 determines that the key is contacted via the left palm contact P_{L} or the right palm contact P_{R} whose electric resistance is smaller than that of the other.

The device control IC 23 (as the determining section) receives the contact strength from the contact detecting unit 21, compares the received contact strength with a predetermined threshold, and recognizes the contact state of the object.

The device control IC 23 (as the communication section) informs the motherboard 30a (shown in FIG. 5) of the determined contact state and the key hitting conducted by the left or right hand.

The display driver 22 (as the display controller) changes indication mode of the image of an input device in accordance with the contact state and the use of the left or right hand. For instance, different indications are given for the keys “S”, “D” and “F” depressed by the left hand, and the keys “J”, “K” and “L” depressed by the right hand. Refer to FIG. 16.

The input device 60 may include the speaker driver 25 and speaker 26 similarly to the input device 20 of the first embodiment. The device control IC 23 controls the speaker driver 25, which produces the predetermined recognition sound in: accordance with the relationship between the position of the object and the position of the hit key on the virtual keyboard, and the contact state. Further, different sounds will be produced for the use of the left and right hands.

The light emitting unit 27 emits light in accordance with the contact state, and emits different lights or blinks lights at different intervals for the use of the left and right hands. Alternatively, the input device 60 may include two light emitting units on the opposite sides thereof, and may emit light on the left or right side in accordance with the position of the object brought into contact.

The memory 24 stores histories of the contact position of the object, contact strength, use of the left or right hand, for a given length of time.

The information processing program and other programs are the same as those of the first embodiment, and will not be described here.

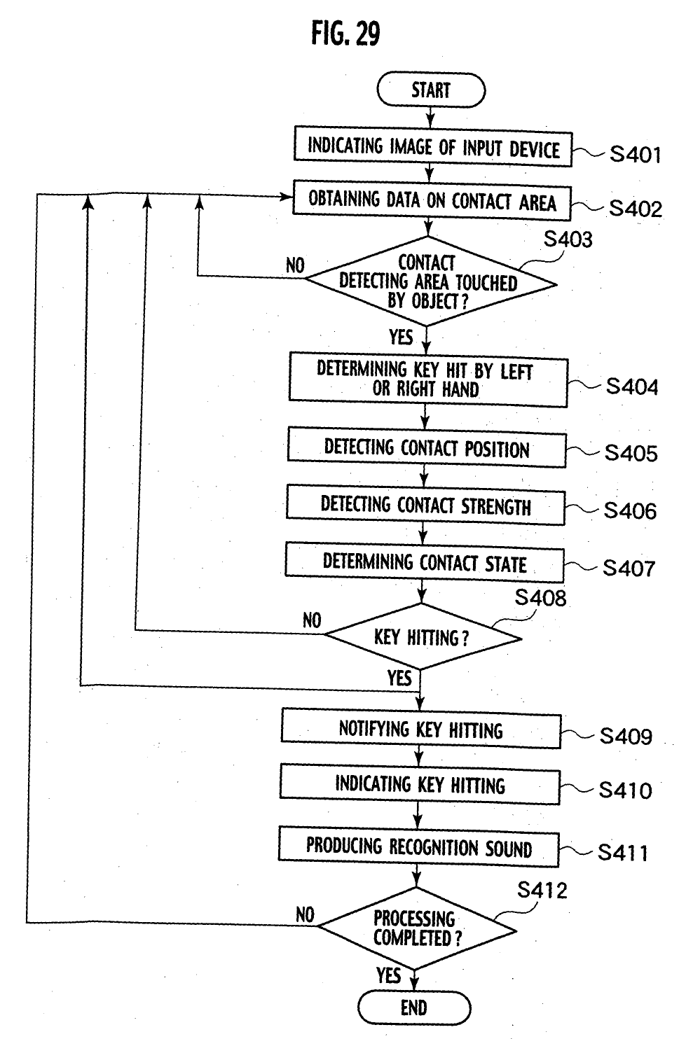

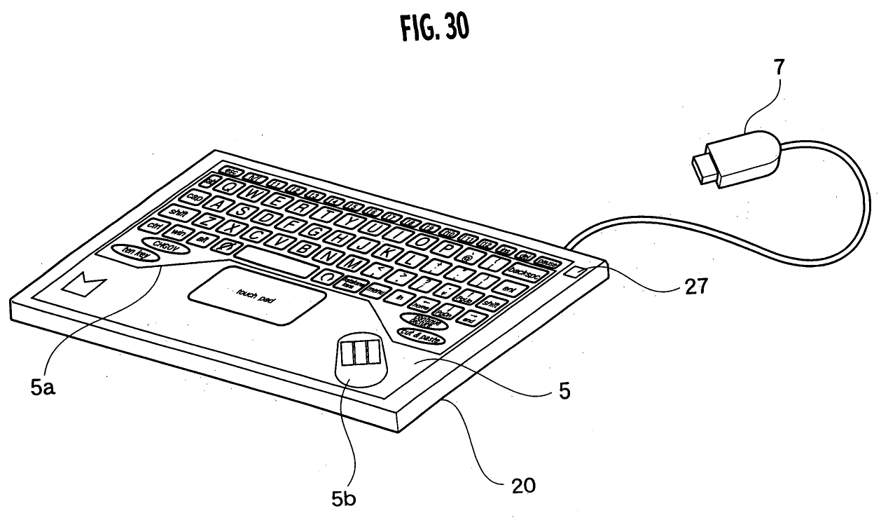

An information processing method will be described with reference to FIG. 29. The method is carried out by the device control IC 23 and so on which executes the program stored in the memory 24.

It is assumed that the user hits keys on the virtual keyboard.

Steps 401 to 403 are the same as steps S101 to S103 shown in FIG. 18, and will not be described here.

In step S404, the input device 60 detects whether a key has been hit by the user's left or right hand. For instance, the input device 60 detects whether the hit key is in the left palm detecting area or the right palm detecting area, on the basis of a signal from the resistance detecting layer 65. Specifically, when a certain key detecting element 66 is in the “contact” state, the resistance detecting unit 71 determines that the key detecting element 66 is in contact with the hit key via the left palm contact P_{L} or the right palm contact P_{R} whose electric resistance is smaller than the other.

The input device 60 detects the position of the user's finger in contact with the contact detecting layer 10a of the touch panel 10 in step S405. In step S406, the input device 60 detects strength with which the user's finger is in contact with the key.

Steps S407 and S408 are the same as steps S106 and S107, and will not be described here.

In step S409, the input device 60 informs the motherboard 30 that the key has been hit by the left or right hand.

The input device 60 changes the indication mode on the virtual keyboard in step S410. Specifically, the indication mode is changed with respect to the brightness of the hit key, color, shape, thickness of the profile line, blinking/steady lighting, and blinking intervals, and so on. In this case, the indication mode depends upon whether the key has been hit by the left or right hand.

Steps S411 and S412 are the same as steps S110 and S111, and will not be described here.

In the second embodiment, the combination of the input device 60, information processing method and program, and resistance detecting unit 71 enables to determine whether the key has been hit by the user's left or right hand. In the case of the popular QWERTY type keyboard, the user's left hand fingers are on the home position of “A”, “S”, “D” and “F” keys while the user's right fingers are on the home position of “J”, “K”, “L”, and “;”. If the user happens to touch the left (or right) home position key with a right (or left) finger, the hit key will not be recognized to be at the home position. This is effective in reducing inputting errors. Alternatively, the keys used for the foregoing determination may be freely selected by the user.

Further, some keys are positioned near the center of the keyboard and may be hit by the left or right hand. It is possible to recognize whether or not such keys are hit by the proper fingers. Histories of hitting of such keys are stored and accumulated, which is effective in letting the user learn to hit the keys by proper fingers.

### Other Embodiments

Although the invention has been described above with reference to certain embodiments, the invention is not limited to the embodiments described above. Modifications and variations of the embodiments described above will occur to those skilled in the art, in the light of the above teachings.

For example, the input unit 3 is integral with the computer main unit 30 in the first and second embodiments. Alternatively, an external input device may be connected to the computer main unit 30 using a universal serial bus (USB) or the like with an existing connection specification.

FIG. 30 shows an example in which an external input device 20 is connected to the microcomputer main unit, and images of the input device (e.g., a virtual keyboard 25 and a virtual mouse 23) are shown on the display unit (LCD) 5. A USB cable 7 is used to connect the input device 20 to the microcomputer main unit. Information concerning keys hit on the keyboard is transmitted to the microcomputer main unit from the input device 20. The processed data are shown on the display unit connected to the computer main unit.

The input device 20 of FIG. 30 processes the information and shows the virtual keyboard 5a (as shown in FIG. 18 to FIG. 21) as the input unit 3, virtual mouse 5b and so on the display unit 5, similarly to the input device 20 of FIG. 1. These operations may be executed under the control of the microcomputer main unit.

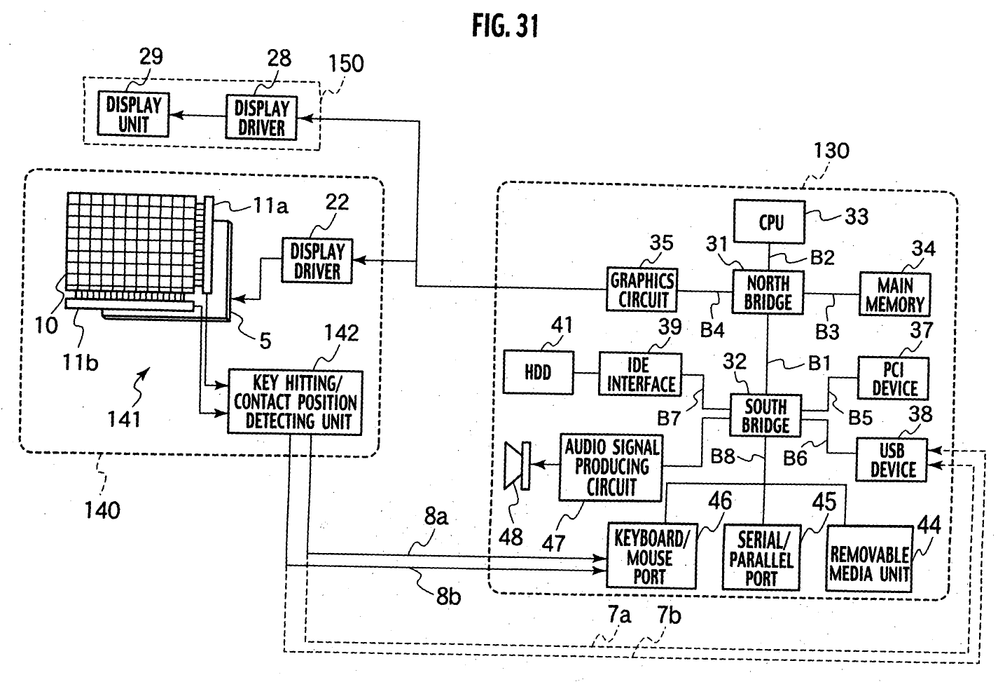

Referring to FIG. 31, a microcomputer main unit 130 is connected to an external input unit 140 provided with an input device 141. The input device 141 receives digital image signals for the virtual keyboard on so on from a graphics circuit 35 (of the microcomputer main unit 130) via a display driver 22. The display driver 22 lets the display unit 5 show images of the virtual keyboard 5a and so on.

A key hitting/contact position detecting unit 142 detects a contact position and a contact state of the object on the contact detecting layer 10a of the touch panel 10, as described with reference to FIG. 18 to FIG. 21. The detected operation results of the virtual keyboard or mouse are transmitted to a keyboard/mouse port 46 of the computer main unit 130 via a keyboard connecting cable (PS/2 cables) or a mouse connecting cable (PS/2 cables).

The microcomputer main unit 130 processes the received operation results of the virtual keyboard or mouse, let the graphics circuit 35 send a digital image signal representing the operation results to a display driver 28 of a display unit 150. The display unit 29 indicates images in response to the digital image signal. Further, the microcomputer main unit 130 sends the digital image signal to the display driver 22 from the graphics circuit 35. Hence, colors and so on of the indications on the display unit 5 (as shown in FIG. 16 and FIG. 17) will be changed.

In this case, the microcomputer main unit 130 operates as a display controller, a contact strength detecting unit, and a contact state determining unit.

Alternatively the operation results of the virtual keyboard and mouse may be sent to the USB device 38 of the microcomputer main unit 130 via USB cables 7a and 7b in place of the keyboard connecting cable and mouse connecting cable, as shown by dash lines in FIG. 31.

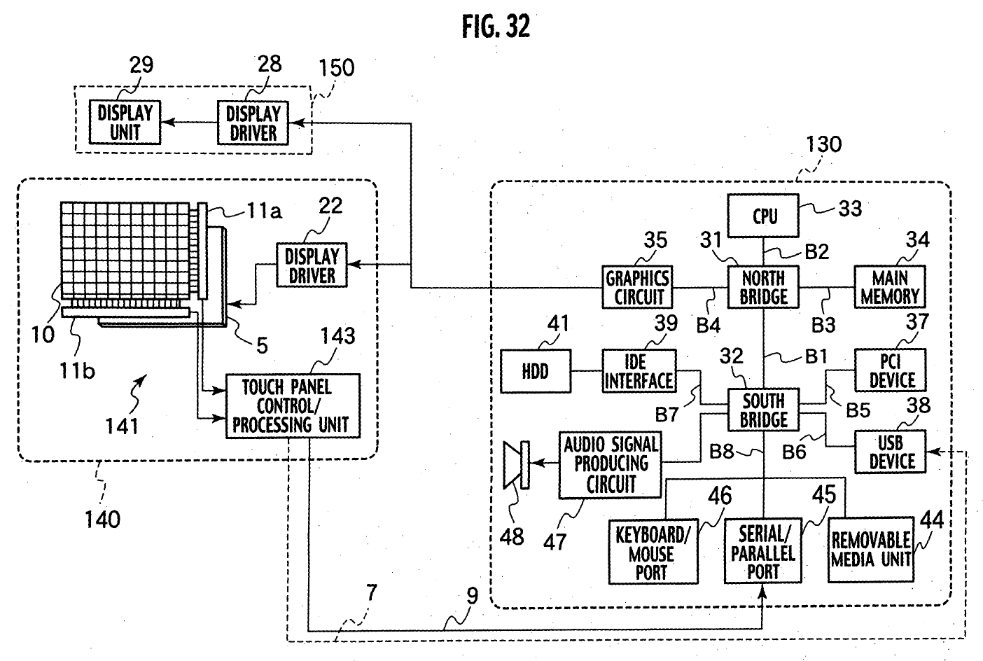

FIG. 32 shows a further example of the external input unit 140 for the microcomputer main unit 130. In the external input unit 140, a touch panel control/processing unit 143 detects keys hit on the touch panel 10, and sends the detected results to the serial/parallel port 45 of the microcomputer main unit 130 via a serial connection cable 9.

The microcomputer main unit 130 recognizes the touch panel as the input unit 140 using a touch panel driver, and executes necessary processing.

In this case, the microcomputer main unit 130 operates as a display controller, a contact strength detecting unit, and a contact state determining unit.

In the example shown in FIG. 32, the operation state of the touch panel may be sent to the USB device 38 via the USB connecting cable 7 in place of the serial connection cable 9.

In the first and second embodiments, the touch panel 10 is provided only in the input unit 3. Alternatively, an additional touch panel 10 may be provided in the display unit.

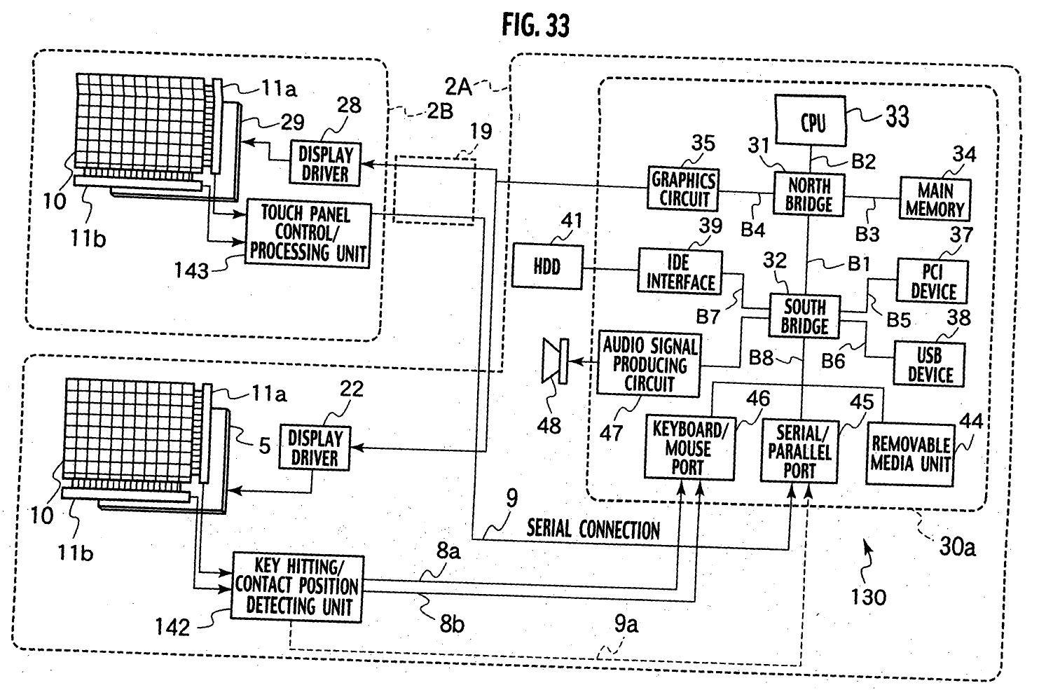

Referring to FIG. 33, the additional touch panel 10 may be installed in the upper housing 2B. Detected results of the touch panel 10 of the upper housing 2B are transmitted to the touch panel control/processing unit 143, which transfers the detected results to the serial/parallel port 45 via the serial connection cable 9.

The microcomputer main unit 130 recognizes the touch panel of the upper housing 2B using the touch panel driver, and performs necessary processing.

Further, the microcomputer main unit 130 sends a digital image signal to a display driver 28 of the upper housing 2B via the graphics circuit 35. Then, the display unit 29 of the upper housing 2B indicates various images. The upper housing 2B is connected to the microcomputer main unit 130 using a signal line via the hinge 19 shown in FIG. 1.

The lower housing 2A includes the key hitting/contact position detecting unit 142, which detects a contact position and a state of the object on the detecting layer 10b of the touch panel 10 as shown in FIG. 18 to FIG. 21, and provides a detected state of the keyboard or mouse to the keyboard/mouse port 46 via the keyboard connection cable or mouse connection cable (PS/2 cables).

The microcomputer main unit 130 provides the display driver 22 (of the input unit 140) with a digital image signal on the basis of the operated state of the keyboard or mouse via the graphics circuit 35. The indication modes of the display unit 5 shown in FIG. 16 and FIG. 17 will be changed with respect to colors or the like.

In this case, the microcomputer main unit 130 operates as a display controller, a contact strength detecting unit, and a contact state determining unit.

The operated results of the keyboard or mouse may be transmitted to the serial/parallel port 45 via the serial connection cable 9a in place of the keyboard or mouse connection cable, as shown by dash lines in FIG. 33.

In the lower housing 2A, the key hitting/contact position detecting unit 142 may be replaced with a touch panel control/processing unit 143 as shown in FIG. 26. The microcomputer main unit 130 may recognize the operated results of the keyboard or mouse using the touch panel driver, and perform necessary processing.

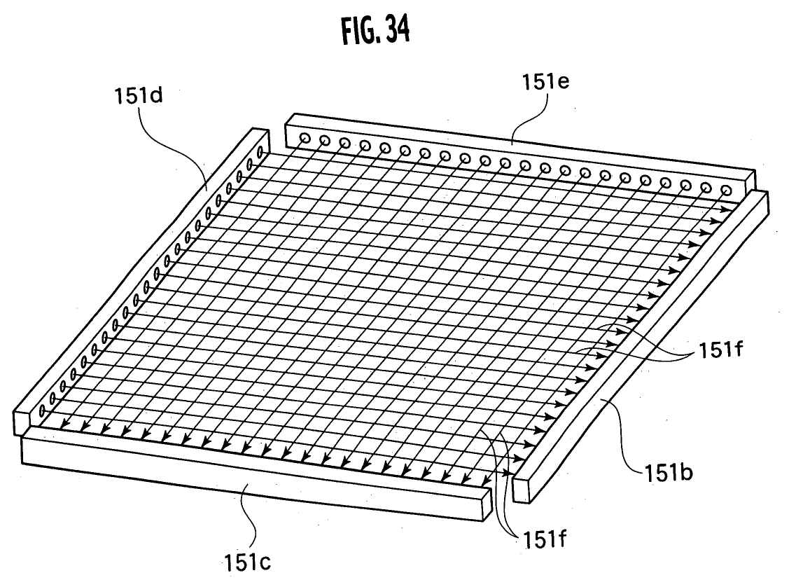

The resistance film type touch panel 10 is employed in the first and second embodiments. Alternatively, an optical touch panel is usable as shown in FIG. 34. For instance, an infrared ray scanner type sensor array is available. In the infrared ray scanner type sensor array, light scans from a light emitting X-axis array 151e to a light receiving X-axis array 151c, and from a light emitting Y-axis array 151d to a light receiving Y-axis array 151b. A space where light paths intersect in the shape of a matrix is a contact detecting area in place of the touch panel 10. When the user tries to press the display layer of the display unit 5, the user's finger traverses the contact detecting area first of all, and breaks in a light path 151f. Neither the light receiving X-axis sensor array 151c nor the light receiving Y-axis sensor array 151 receive any light. Hence, the contact detecting unit 21 (shown in FIG. 4) can detect position of the object on the basis of the X and Y coordinates. The contact detecting unit 21 detects strength of the object traversing the contact detecting area (i.e., strength by which the object comes in contact with the display unit 5) and a feature quantity depending upon the strength. Hence, the contact state will be recognized. For instance, when a fingertip having a certain sectional area traverses the contact detecting layer, a plurality of infrared rays are broken out. An increase ratio of the broken infrared rays per unit time depends upon a speed of the fingertip traversing the contact detecting layer. In other word, if strongly pressed onto the display panel, the finger quickly passes over the contact detecting layer. Therefore, it is possible to check whether or not the key is hit strongly in accordance with the number of broken infrared rays.

The portable microcomputer is exemplified as the terminal device in the first and second embodiments. Alternatively, the terminal device may be an electronic databook, a personal digital assistant (PDA), a cellular phone, and so on.

In the flowchart of FIG. 18, the contact position is detected first (step S104), and then the contact strength is detected (step S105). Steps S104 and S105 may be executed in a reversed order. Step S108 (NOTIFYING KEY HITTING), step S109 (INDICATING KEY HITTING) and step S110 (PRODUCING RECOGNITION SOUND) may be executed in a reversed order. The foregoing hold true to the processes shown in FIG. 20 and FIG. 29.

Finally, step S404 (recognition of the left or right palm) and step S405 may be executed in a reversed order.

What is claimed is:

1. An input device comprising:
a display unit indicating an image of an input position;
a contact position detecting unit detecting a position of an object brought into contact with a contact detecting layer provided on a display layer of the display unit;
a contact strength detecting unit detecting contact strength of the object brought into contact with the contact detecting layer; and
a contact state determining unit which extracts a feature quantity of the detected contact strength, compares the extracted feature quantity with a predetermined threshold, and determines a contact state of the object.

2. The input device of claim 1, wherein variations of a size of a contact area is extracted as a feature quantity.

3. The input device of claim 1, wherein variations of a contact pressure is extracted as a feature quantity.

4. The input device of claim 1 further comprising a display controller which changes an indication mode of an image of the input device in accordance with the contact state determined by the contact state determining unit.

5. The input device of claim 1 further comprising a sound producing unit which produces a predetermined recognition sound in accordance with a relationship between a position of the object detected by the contact position detecting unit and a position of the image of the input position on the display unit.

6. The input device of claim 1 further comprising a contact state informing unit which informs the contact state to units which operate in response to a signal issued by the input device.

7. The input device of claim 1 further comprising a light emitting unit which emits light in accordance with the detected contact state.

8. The input device of claim 1, wherein the image of the input position is an image of a keyboard, and the input device further comprises a left/right hand detecting unit which detects whether a key is hit by a left or right hand.

9. The input device of claim 1, wherein the contact strength detecting unit having;
a first base and a second base stacked with their electrodes facing with one another; and
different height dot spacers sandwiched by the first and second bases.

10. An input device comprising:
a display unit indicating an image of an input position;
a contact position detecting unit detecting a position of an object traverses a contact position detecting layer provided on a display layer of the display unit;
a contact strength detecting unit detecting contact strength of the object brought into contact with the contact detecting layer; and
a contact state determining unit which extracts a feature quantity of the detected contact strength, compares the extracted feature quantity with a predetermined threshold, and determines a contact state of the object.

11. A microcomputer comprising:
a display unit indicating an image of an input position;
a contact position detecting unit detecting a position of an object brought into contact with a contact detecting layer provided on a display layer of the display unit;
a contact strength detecting unit detecting contact strength of the object brought into contact with the contact detecting layer;
a contact state determining unit which extracts a feature quantity of the detected contact strength, compares the extracted feature quantity with a predetermined threshold, and determines a contact state of the object; and
a processing unit which performs processing in accordance with the detected contact state of the object and information entered through the contact detecting layer.

12. The microcomputer of claim 11 further comprising a display controller changing an indication mode of the image of the input position in accordance with the detected contact state.

13. An information processing method comprising:
indicating an image of an input position on a display unit;
detecting a contact position of an object in contact with a contact detecting layer of the display unit;
detecting contact strength of the object;
extracting a feature quantity related to the detected contact strength; and
comparing the extracted feature quantity with a predetermined threshold and determining a contact state of the object on the contact detecting layer.

14. The information processing method of claim 13, wherein variations of a size of a contact area are extracted as a feature quantity.

15. The information processing method of claim 13, wherein variations of a contact pressure are extracted as a feature quantity.

16. The information processing method of claim 13 further comprising changing an indication mode of the image of the input position in response to the determined contact state.

17. An information processing program enabling an input device to:
indicate an image of an input position on a display unit;
detect a contact position of an object brought into contact on a contact detecting layer of display unit;
detect contact strength of the object brought into contact with the contact detecting layer;
extract a feature quantity related to the detected contact strength; and
compare the extracted feature quantity with a predetermined threshold, and determine a contact state of the object on the contact detecting layer.

18. The information processing program of claim 17, wherein variations of a size of a contact area are extracted as s feature quantity.

19. The information processing program of claim 17, wherein variations of contact pressure are extracted as a feature quantity.

20. The information processing program of claim 17, wherein indication modes of an image of the input position are changed in accordance with the determined contact state.
